(19) United States
(12) Patent Application Publication
(10) Pub. No.: US 2011/0173019 A1
(43) Pub. Date: Jul. 14, 2011

(54) Global health-care rates exchange II

(76) Inventor: Anuthep Benja-Athon, New York, NY (US)

(21) Appl. No.: 12/931,337

(22) Filed: Jan. 31, 2011

Related U.S. Application Data
(63) Continuation-in-part of application No. 12/930,397, filed on Jan. 6, 2011.
Application No. 12/930,397 is a continuation-in-part of application No. 12/592,714, filed on Dec. 2, 2009.
Application No. 12/592,714 is a continuation-in-part of application No. 12/584,718, filed on Sep. 11, 2009.
Application No. 12/584,718 is a continuation-in-part of application No. 12/381,654, filed on Mar. 16, 2009.
Application No. 12/381,654 is a continuation-in-part of application No. 12/321,141, filed on Jan. 16, 2009.
Application No. 12/321,141 is a continuation-in-part of application No. 12/069,409, filed on Feb. 11, 2008.
Application No. 12/930,397 is a continuation-in-part of application No. 12/156,674, filed on Jun. 4, 2008.
Application No. 12/156,674 is a continuation-in-part of application No. 11/986,657, filed on Nov. 26, 2007, now abandoned.
Application No. 11/986,657 is a continuation-in-part of application No. 11/803,621, filed on May 16, 2007.
Application No. 11/803,621 is a continuation-in-part of application No. 11/716,062, filed on Mar. 9, 2007, now abandoned.
Application No. 11/716,062 is a continuation-in-part of application No. 11/649,873, filed on Jan. 5, 2007, now abandoned.
Application No. 11/649,873 is a continuation-in-part of application No. 11/637,662, filed on Dec. 13, 2006, now abandoned.
Application No. 11/637,662 is a continuation-in-part of application No. 11/599,847, filed on Nov. 16, 2006, now abandoned.
Application No. 11/599,847 is a continuation-in-part of application No. 11/431,046, filed on May 10, 2006, now abandoned.
Application No. 11/431,046 is a continuation-in-part of application No. 11/543,895, filed on Oct. 6, 2006, now abandoned.
Application No. 11/543,895 is a continuation-in-part of application No. 11/523,945, filed on Sep. 21, 2006, now abandoned.
Application No. 11/523,945 is a continuation-in-part of application No. 11/510,820, filed on Aug. 28, 2006, now abandoned.
Application No. 11/510,820 is a continuation-in-part of application No. 11/477,121, filed on Jun. 29, 2006, now abandoned.
Application No. 11/477,121 is a continuation-in-part of application No. 11/327,973, filed on Jan. 9, 2006, now abandoned.
Application No. 11/327,973 is a continuation-in-part of application No. 11/114,763, filed on Apr. 27, 2005, now abandoned.
Application No. 11/114,763 is a continuation-in-part of application No. 11/196,823, filed on Aug. 4, 2005, now abandoned.
Application No. 11/196,823 is a continuation-in-part of application No. 11/973,866, filed on Oct. 11, 2007, now abandoned.
Application No. 11/973,866 is a continuation-in-part of application No. 11/293,689, filed on Dec. 5, 2005, now abandoned.
Application No. 11/293,689 is a continuation-in-part of application No. 11/150,878, filed on Jun. 13, 2005, now abandoned.
Application No. 11/150,878 is a continuation-in-part of application No. 11/074,236, filed on Mar. 7, 2005, now abandoned.
Application No. 11/074,236 is a continuation-in-part of application No. 11/022,410, filed on Dec. 27, 2004, now abandoned.
Application No. 11/022,410 is a continuation-in-part of application No. 12/322,529, filed on Feb. 4, 2009.
Application No. 12/322,529 is a continuation-in-part of application No. 12/080,433, filed on Apr. 3, 2008.
Application No. 12/080,433 is a continuation-in-part of application No. 12/072,097, filed on Feb. 25, 2008.
Application No. 12/072,097 is a continuation-in-part of application No. 11/242,461, filed on Oct. 4, 2005, now abandoned.

(51) Int. Cl. G06Q 50/00; G06Q 10/00

(52) U.S. Cl. 705/2

(57) ABSTRACT

A system and method for computer-automatically generate relations, compositions and compilations of individual costs related to individual health and health-care services and goods and non-health-care goods and services of or related to health-care providers, buyers and patients in computer servers in a network or networks of servers and computers for managing, distributing and controlling health-care funds and resources of, by and among health-care providers, buyers and patients in America and other nations.

This application is a continuation-in-part of Ser. No. 12/930,397 filed Jan. 6, 2011 entitled Health-care Rates Exchange I, a continuation-in-part of Ser. No. 12/592,714 filed Dec. 2, 2009 entitled Health-care Exchange IV, a continuation-in-part of Ser. No. 12/584,718 filed Sep. 11, 2009 entitled the Health-care Exchange III, a continuation-in-part of Ser. No. 12/381,654 entitled the Adaptable compositions of health information filed Mar. 16, 2009, a continuation-in-part of Ser. No. 12/321,141 entitled the Best system of health and health-care data management filed Jan. 16, 2009 which is a continuation-in-part of Ser. No. 12/069,409 entitled the Filing of Health and Health-care data filed Feb. 11, 2008, a continuation-in-part of Ser. No. 12/156,674 filed Jun. 4, 2008 entitled a precise medical information retrieval, a continuation-in-part of Ser. No. 11/986,657 entitled A hierarchy of medical word headers filed Nov. 26, 2007, a continuation-in-part of Ser. No. 11/803,621 entitled Patients' and physicians' data management filed May 16, 2007, a continuation-in-part of Ser. No. 11/716,062 entitled A sieve of words in health-care data filed Mar. 9, 2007, a continuation-in-part of Ser. No. 11/649,873 entitled A system of calibrating physicians' practices of medicine filed Jan. 5, 2007 (abandoned), a continuation-in-part of Ser. No. 11/637,662 entitled A vital hierarchy of data on diseases filed Dec. 13, 2006 (abandoned), a continuation-in-part of Ser. No. 11/599,847 entitled A hybrid intelligence in medicine filed Nov. 16, 2006, a continuation-in-part of Ser. No. 11/431,046 entitled A system of health-care information management filed Nov. 2, 2006, a continuation-in-part of Ser. No. 11/543,895 entitled Vital elements of speech recognition filed Oct. 6, 2006, a continuation-in-part of Ser. No. 11/523,945 entitled The networking of digital health information filed Sep. 21, 2006, a continuation-in-part of Ser. No. 11/510,820 entitled Words for managing health and health-care information filed Aug. 28, 2006 (abandoned), a continuation-in-part of Ser. No. 11/477,121 entitled the Medical Vocabulary Templates in Speech Recognition filed Jun. 29, 2006 (abandoned), a continuation-in-part of Ser. No. 11/327,973 filed Jan. 9, 2006 entitled Fidelity of physicians' thoughts to digital data conversions (abandoned), a continuation-in-part of Ser. No. 11/114,763 entitled A system of influencing health-care utilizations filed Apr. 27, 2005 (abandoned), a continuation-in-part of Ser. No. 11/196,823 entitled Routing of health information files filed Aug. 4, 2005 (abandoned), a continuation-in-part of Ser. No. 11/973,866 entitled An intelligent system of speech recognizing physicians' data (abandoned), a continuation-in-part of Ser. No. 11/293,689 entitled A system of conserving health-care buyers' resources filed Dec. 5, 2005 (abandoned), a continuation-in-part of Ser. No. 11/150,878 entitled Physicians' optimal management of health information filed Jun. 13, 2005 (abandoned), a continuation-in-part of Ser. No. 11/074,236 entitled A system of management of health-care resources filed Mar. 7, 2005 (abandoned), and a continuation-in-part of Ser. No. 11/022,410 entitled Physicians' way of information productions filed Dec. 27, 2004 (abandoned), a continuation-in-part of Ser. No. 12/322,529 filed Feb. 4, 2009 entitled the Healthcare exchange II, a continuation-in-part of Ser. No. 12/080,433 filed Apr. 3, 2008 entitled Healthcare exchange, a continuation-in-part of Ser. No. 12/072,097 filed Feb. 25, 2008 entitled a Method of empowering owners of health-care resources, and a continuation-in-part of Ser. No. 11/242,461 filed Oct. 4, 2005 entitled a Perfect system of compensations for physicians which are pending.

### FIELD OF INVENTION

The better structures and applications of health-care funds and resources of, among and between individual health-care providers, buyers and patients in America and other nations.

### BACKGROUND OF THE INVENTION

In the current health-care systems in America, the costs, values or prices of health-care and health-care services being paid to and affecting the compensations for health-care and earnings of health-care providers and costs to health-care buyers and consumers are artificially, unrealistically created and applied to said providers, buyers and consumers by third parties including the government through its departments and agencies in America. Consequently, there are biased distributions and drains of health-care funds and resources away from said providers, buyers and consumers, thus, contributing to the causes of the current crises and woes, including escalating costs straining all Americans and the nation and bankrupting the current health-care systems and America, which cannot be solved by the continual applications of said system in America.

In the better, if not the best, health-care system in America invented by the present applicant embodied by said pending patent applications and related, the present invention uniquely effects the converses of supra.

And implemented into said inventions, the present invention provides yet another unique and powerful innovation achievable, attainable and applicable only in said systems and methods of said pending patent applications which further enhance and steadfastly, speedily and infinitely improve the quality and standard of health-care and living for people all over the world. In fact, said pending patent applications including the present invention uniquely, powerfully and speedily transform the entire and global health-care system human civilizations had and experienced up to 2010 into the most modern, advanced, powerful, efficient and benevolent health-care system benefitting every human, society and humanity on earth human now and in many millenniums to come.

Further to the claims and descriptions in said pending patent applications, consequently, the present invention together with said pending patent applications are the only means and solution for solving the current health and health-care woes increasing morbidity and mortality affecting Americans and, consequently, providing the best health-care system and spawning innovations in medicine, sciences and health-care the world ever known and will have and immediately and immensely benefitting billions of people and successive generations and humanity. Therefore, the health, well being and standard of living of and diminishing costs of health and health-care services—thence decreased morbidity and mortality—for Americans including seniors and billions of people in 2011 and beyond will be effected and be significantly improved by the present invention.

### SUMMARY OF THE INVENTION

The present invention is a further improvement of the prototype infra in said pending patent applications and yet an improvement of said Ser. No. 12/930,397 entitled Health-care Rates Exchange I.

The present invention provides a system and method for managing, distributing and controlling health-care funds and resources of, by, between and among individual health-care providers and buyers and consumers in localities, places and regions in America and other nations and, consequently, immensely, nationally and globally effecting and affecting the managements and controls of health-care funds and resources and related resources of, between and among said individual health-care providers and buyers and consumers in any and different and diverse settings, localities, places and regions America and other nations.

Specifically, the present invention provides an innovative and unique computerized system and method for creating, generating and negotiating individual costs, rates, values and charges related to individual health and health-care services, goods, equipment and medications, provided by individual health-care providers to and being bought, bartered and consumed by individual health-care buyers and consumers, by and between said individual providers and individual health-care buyers in same individual localities, places or regions in America or other nations, or in different and diverse settings, localities, places and regions in America and other nations, in adaptable and expanding SQL databases in and manage by a SQL Server in a operating and functioning computer server or servers in a network or networks of said servers, and computers, laptops, mobile and wireless communication devices including smartphones, teleconferencing platforms and related devices.

One of the beneficial consequences for people and nations effected by the present invention, therefore, is the utilizations of the resources of said individual health-care providers and individual health-care buyers in individual same localities, places or regions in America or other nations for assisting and effecting and managing, distributing and controlling health-care funds and resources of individual buyers and consumers in any and other localities, places and regions, cities and states, etc. in America or other nations by and among said individual health-care providers, health-care buyers and consumers including individual patients.

In summary, the present invention exerts immense effects on said pending patent applications and related—the Utopian Healthcare System—affecting all human civilizations speedily improve the quality and standard of and future innovations in health-care and quality and standard living for people all over the world.

Added to and implemented into said inventions, the present invention provides yet another unique and powerful innovation achievable, attainable and applicable only in said systems and methods of said pending patent applications which further enhance and steadfastly, speedily and infinitely improve the quality and standard of health-care and living for people all over the world.

Further to the claims and descriptions in said pending patent applications, consequently, the present invention together with said pending patent applications are the only means and solution for solving the current health and health-care woes increasing morbidity and mortality affecting Americans and, consequently, producing the best health-care system and spawning innovations in medicine, sciences and health-care the world ever known and will have and immediately and immensely benefitting billions of people and successive generations and humanity.

### BRIEF DESCRIPTION OF THE PREFERRED EMBODIMENTS

Since the present invention is the improvement of said two pending patent applications for activating and enabling said related pending patent applications related to other pending patent applications not mentioned herein—the Cloud Healthcare Exchange—to understand the preferred embodiments of the present invention, therefore, it is necessary to invoke at least said Ser. No. 12/930,397 filed Jan. 6, 2011 entitled Health-care Rates Exchange I, Ser. No. 12/592,714 filed Dec. 2, 2009 entitled Health-care Exchange IV, Ser. No. 12/584,718 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians which are the functioning and operating computerized systems of payments and related disbursements and barters in a functioning and operating computer server or servers.

Further empowering said pending patent applications, the innovative and unique present invention further expands the realm of the better or best health-care system in the world wherein not only the transactions, negotiations, exchanges, transfers, managements and controls of health-care funds and resources of individual health-care providers and individual health-care buyers and patients are between and among individual health-care providers and individual health-care buyers and patients, in (or outside) a network or networks of computer servers, computers and communications devices and teleconferencing platforms, but also fulfill individual needs and demands of said individual health-care providers and individual health-care buyers and patients anywhere and in any settings, circumstances, localities, places, municipalities, towns, cities, states, regions and territories in America and other nations. Furthermore, the present invention provides the direct and honest, equitable, accurate or true system of compensations of health-care and health-care services for individual health-care providers and costs of health-care and health-care services of individual health-care buyers and patients in America and other nations.

Said pending patent applications extensively teach and use—a vital component or requisite core—an innovative and unique system and method for computer-automatically and repetitively or continually scanning and matching individual words, terms, phrases and sentences including related individual evaluations, tests, laboratories, procedures, treatments and surgeries, which are integral components of said relational information and data on or related to said individual patients used and use and generated in said devices by said individual physicians in said submissions of said information and data on health, health-care and health-care services related to said individual diagnoses and said physicians and individual patients using said keyboards and interactive Web pages and electronic templates to said servers, and upon said individual inputs of said individual words, terms, phrases and sentences into said processor units and memories, said process for computer-automatically scanning and matching said submitted individual words, terms, phrases and sentences, with same, similar and equivalent words, terms, phrases and sentences related to individual prices, monetary values or costs—the prototype of the present invention—in said processor units and memories and outputting said scanned and matched said words, terms, phrases and sentences and related individual prices, monetary values or costs from said processor units and memories to, to be related and compiled with compiled words, terms, phrases and sentences and related prices, monetary values or costs into adaptable and expanding relational compositions in said SQL databases in said functioning and operating computerized systems of payments and related disbursements and barters in said functioning and operating computer server or servers, enabled and effected by and according to the innovative computer programs and software and stored procedures.

Enabled by the present patent applicant and said unique and innovative computer programs and software and stored procedures invented and created by said patent applicant and various applications of said Wordpad, Notepad, .txt programs, JavaScript, AJAX, HTML, .net in said servers, the achievements of the objectives and goals of the present invention by said individual providers and individual buyers are speeded by the creations and generations of adaptable and expanding relations, compositions and compilations of hundreds of thousands of individual words, terms, phrases and sentences, which are integral components of said health, health-care and health-care-service information and data on or relating to diseases and disorders and patients used and use by physicians of all and diverse medical and surgical practices or specialties for and in the communications of said information and data among and between physicians and between physicians and patients, representing medical and surgical words, terms, phrases and sentences in medical and surgical categories such as, but not limited to, Evaluations, Chief Complaints, Allergies, Family Histories, Vital Sign Measurements, Reviews of Systems, Physical Examinations, Infectious Diseases, Diagnoses, Differential Diagnoses, Results of Laboratories such as, but not limited to, Imaging or Imagings, Body Fluid Tests and Tissues Examinations, Assessments and Plans, Immunizations, Medications, Treatments, Surgeries, Recommendations, Guidelines, Advises, Referrals and Follow-ups, etc., and, enabled and effected by and according to said innovative computer programs and software and stored procedures are processed in said processor units and memories and computer-automatically outputted to, to be related and compiled in and related to individual SQL keys in said adaptable and expanding SQL databases in and manage by said SQL Server. Said medical and surgical categories related to information and data on all diagnoses, diseases and disorders and related categories herein in about 85 medical and surgical specialties or practices apply to all physicians, including other health-care providers, described herein in America and other nations.

In particular, however, the present invention places emphasis on particular said words, terms, phrases and sentences representing individual payable health-care and health-care services, in said medical and surgical categories of Evaluations, Laboratories, Imaging, Body Fluid Tests and Tissues Examinations, Medications, Drugs, Pharmaceuticals, Devices, Equipment, Procedures, Treatments, Surgeries, Recommendations, Guidelines, Advises, Referrals and Follow-ups in about 85 medical and surgical specialties or practices collectively known herein as individual payables related to individual diagnoses or individual diagnoses in individual groups of same, equivalent or similar diagnoses of diseases and disorders and goods, medications, drugs, pharmaceuticals, equipment, devices, related individual buyers and individual providers and information and data on office locations or practices such as, but not limited to, zip codes, area codes, locations, addresses and places of said individual providers and individual buyers related to individual health-care consumers, enabled by and effected in said Wordpad, Notepad, .txt programs, JavaScript, AJAX, HTML, .net and enabled and effected by and according to said innovative computer programs and software and stored procedures in said servers, which are processed in said processor units and memories and computer-automatically outputted to, to be related and compiled in and related to individual SQL keys in said adaptable and expanding SQL databases in and manage by said SQL Server.

For example, said Evaluations category comprises at least 20-40 items such as, but not limited to comprehensive consultation, extensive consultation, intermediate consultation, brief consultation, comprehensive office visit, extensive office visit, intermediate office visit, brief office visit, comprehensive, extensive consultation, intermediate consultation, brief consultation, comprehensive hospital consultation, extensive hospital consultation, intermediate hospital consultation, brief hospital consultation, etc. related to corresponding interactive blank boxes for keyboarding and/or touch-screening individual costs, rates, values and charges related to said individual items for composing said relations and compositions of said individual items and related payables related to said individual providers related to individual medical or surgical specialties or practices in said adaptable interactive linked Web pages and electronic templates in said servers and in said viewing screens of said devices and teleconferencing platforms. Said preferred embodiment applies to said individual payable health-care and health-care services in said medical and surgical categories related to any and all medical and surgical specialties or practices related to individual providers as defined in the claims infra.

The present invention, like said pending patent applications, provides and utilizes said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and said innovative computer programs and software and stored procedures coupled to, communicating with and commanding said SQL Server, processor units and memories, adaptable interactive linked Web pages and electronic templates and numerous linked interactive pop-up and drop-down lists in said viewing screens, computer programs or software for calculating and statistically calculating and manipulating said costs, prices, values and fees, teleconferencing platforms comprising teleconferencing technologies and related devices and equipment including video equipment, and said devices including smartphones for repetitively and continually accessing said servers and generating, adjusting, updating, adding, adapting, setting and resetting said relations, compositions and compilations in said processor units, memories and adaptable and expanding SQL databases by, among or between said individual buyers and individual providers comprising keyboards and viewing screens including touch-enabled viewing screens or touchscreens, enabled by Web browsers and said Web server in said network or networks.

The present invention are implemented and effected by said innovative computer programs and software and stored procedures—invented and developed by the present patent applicant which were filed with and are stored in the Library of Congress in Washington, D.C.—for creating and generating said adaptable interactive linked Web pages and electronic templates and numerous linked interactive pop-up and drop-down lists comprising said individual payables and interactive blank boxes for creating, generating, adapting and expanding said adaptable and expanding relations, compositions and compilations in said adaptable interactive linked Web pages and electronic templates and in said processor units, memories and adaptable and expanding SQL databases, for creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers related to individual payables and related non-health and non-health-care goods and services by and among said individual buyers, individual patients and said individual providers, for calculating, computing, statistically analyzing said individual ask costs, prices, values and fees and related said bids and counteroffers related to said individual payables or non-health and non-health-care services, goods, equipment related to said individual providers and individual buyers including individual patients and related information and data on offices, practices, businesses and wages, salaries and compensations and on office, practice, business locations and addresses and related individual localities, places and regions in America and other nations, applying calculations, computations and statistics on said relations, compositions and compilations for guiding and effecting said relations, compositions and compilations in said processor units and memories and retrieving from said processor units, memories and SQL databases and displaying said adaptable relations, compositions and compilations and related calculations, computations and statistical analyzes and manipulations of said individual relations, compositions and compilations in said servers in said servers and in said viewing screens of said devices and said teleconferencing platforms.

Further to supra, therefore, the present invention provides a system and method for generating and managing adaptable and expanding relations, compositions and compilations of individual non-negotiable or fixed ask costs, prices, values or fees and related individual payable health and health-care services, tests, goods, equipment and medications henceforth individual payables generated by and related to physicians, individual physicians, individual groups of physicians, hospitals, individual hospitals, clinics, individual health-care clinics, facilities, individual health-care facilities, departments or individual departments henceforth collectively known as individual providers and relations, compositions and compilations of individual negotiable or adjustable ask costs, prices, values and fees related to individual payables related to individual providers and related cost, price, value and fee bids and related cost, price, value and fee counteroffers and related settled, agreed or negotiated costs, prices, values and fees of, related to and among said individual providers and health-care buyers, individual health-care buyers, individual groups of health-care buyers or individual governments henceforth collectively known as individual buyers related to said individual payables and non-health and non-health-care goods and services generated and composed by and between said individual providers and related individual buyers in same individual localities, places or regions in America or other nations or in different and diverse settings, circumstances, localities, places, municipalities, towns, cities, states, regions and territories in America and other nations in adaptable and expanding SQL databases in and manage by a SQL Server in a operating and functioning computer server or servers henceforth servers for enabling, generating and managing said relations, compositions and compilations related to said individual providers and individual buyers for enabling and effecting the applications of said relations, compositions and compilations for managing human resources and managing and controlling health-care funds and resources including costs of individual payables of and for said individual providers and individual buyers in said servers in a network or networks of said servers, and computers, laptops, mobile and wireless communication devices, teleconferencing platforms and related devices and the Internet henceforth devices.

The present invention provides a method for generating adaptable relations and compositions on information and data on office and practice locations and addresses on said individual providers and related individual medical or surgical specialties or practices and related relations and compositions on information and data on office and business locations and addresses and relations and compositions on information and data on residence locations and addresses on said individual patients related to said individual buyers and related individual buyers' office and business locations and addresses by said individual providers and/or said individual providers' staff and employees and individual buyers and/or said individual buyers' staff and employees including individual patients in localities, places and regions in America and other nations using said adaptable interactive linked Web pages and electronic templates and linked numerous interactive pop-up and drop-down lists in said viewing screens of said devices and submitting said information and data to said processor units and memories from which said relations and compositions are computer-automatically outputted to, related to individual SQL keys and compiled in said adaptable and expanding SQL databases in and manage by said SQL Server in said servers in said network or networks.

Further to supra, the present invention further provides a method for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual ask costs, prices, values and fees and related bids and counteroffers and related settled, agreed or negotiated costs, prices, values and fees related to individual payables or related non-health and non-health-care goods and services by and among said individual providers and related individual buyers including individual patients. One of the preferred embodiments of the present invention enables said individual providers and/or said individual providers' staff and employees and individual buyers and/or said individual buyers' staff and employees including individual patients in any settings, circumstances, localities, places, municipalities, towns, cities, states, regions and territories in America and other nations using said adaptable interactive linked Web pages and electronic templates and linked numerous interactive pop-up and drop-down lists related to said individual payables or non-health and non-health-care goods and services and related interactive blank boxes for creating, generating, first, relations and compositions on information and data on office and practice locations and addresses on said individual providers and related individual medical or surgical specialties or practices, related said individual negotiable or adjustable ask costs, prices, values and fees, related said cost, price, value and fee counteroffers and said settled, agreed or negotiated costs, prices, values and fees related to individual payables by said individual payables and by said individual providers and/or said individual providers' staff and employees using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled in said adaptable and expanding SQL databases in and manage by said SQL Server in said servers,

second, relations and compositions on information and data on office and business locations and addresses on said individual buyers and related said individual cost, price, value and fee bids and said settled, agreed or negotiated costs, prices, values and fees related to individual payables and non-health-care goods and services by said individual buyers and/or said individual buyers' staff and employees including individual patients using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled with related said individual providers' relations, compositions and compilations in said adaptable and expanding SQL databases, and, third, relations and compositions on information and data on residence locations and addresses on said individual patients related to said individual buyers and related individual buyers' office and business locations and addresses using said adaptable interactive linked Web pages and electronic templates and linked numerous interactive pop-up and drop-down lists and interactive blank boxes in said viewing screens of said devices for generating and submitting said information and data via the Internet to said processor units, memories from which said relations and compositions on office and practice locations are computer-automatically outputted to, related to individual SQL keys and compiled with related said individual providers' and individual buyers' relations, compositions and compilations in said adaptable and expanding SQL databases.

Further to supra, effected by said individual providers and/or said individual providers' staff and employees and/or said individual buyers and/or said individual buyers' staff and employees including individual patients using said interactive blank boxes for generating, enabling, adjusting, updating, adapting, setting and resetting said relations, compositions and compilations in said viewing screens of said devices or in said teleconferencing platforms in said network or networks, a process for retrieving said relations, compositions and compilations in said adaptable and expanding SQL databases into said adaptable interactive linked Web pages and electronic templates in said viewing screens and adjusting, updating, adapting, editing, setting and resetting, if enabled and effected by and according to said innovative computer programs and software, said relations, compositions and compilations and, consequently, in said processor units, memories and adaptable and expanding SQL databases.

The first preferred embodiment of the present invention provides a method for accessing said servers by said individual providers and/or said individual providers' staff and employees using said devices and upon prompting by said devices, a process for computer-automatically and continually generating individual electronic templates comprising said individual words, terms and phrases related to said individual payables related to said individual medical or surgical specialties or practices and related individual interactive blank boxes for keyboarding and/or touch-screening individual ask costs, rates, values and charges henceforth also known as asks to relate and compose said relations and compositions of said individual words, terms and phrases and related payables in said adaptable interactive linked Web pages and electronic templates for generating relations, compositions and compilations, enabled and effected by at least HTML, Java Script and AJAX and enabled and effected by and according to said innovative computer programs and software and stored procedures, in said servers and said viewing screens of said devices and teleconferencing platforms in said network or networks. Subsequently, the present invention provides a method for computer-automatically creating and generating individual adaptable relations, compositions and compilations of said individual costs, prices, values and fees and related individual payables related to individual providers and related medical and surgical specialities or practices and related information and data on office and practice locations and addresses using said adaptable interactive linked Web pages and electronic templates and numerous linked interactive pop-up and drop-down lists and said interactive blank boxes in said viewing screens of said devices and in said teleconferencing platforms and keyboarding and/or touch-screening said numerous linked interactive pop-up and drop-down lists to create and generate individual relations and compositions on said individual fixed or non-negotiable ask costs, rates, values or charges related to said individual payables related to said individual providers related to individual medical or surgical specialties or practices related to information and data on office and practice locations and addresses such as, but not limited to, individual zip codes or area codes in said interactive blank boxes and submitting said relations, compositions and compilations by said individual providers and/or said individual providers' staff and employees to said processor units and memories from which said relations, compositions and compilations are computer-automatically outputted to, related and compiled in said adaptable and expanding SQL databases in said servers. Further more, the present invention provides a method for continually retrieving said relations, compositions and compilations in said adaptable and expanding SQL databases into said adaptable interactive linked Web pages and electronic templates in said viewing screens and adjusting, updating, adapting, editing, setting and resetting said relations, compositions and compilations related to said individual providers by said individual providers and/or said individual providers' staff and employees using said interactive blank boxes for generating, enabling, adjusting, updating, adapting, setting and resetting said individual costs, rates, values and charges related to said individual providers and, consequently, in said processor units, memories and adaptable and expanding SQL databases. In addition, effected by said individual providers and/or said individual providers' staff and employees and/or said individual buyers and/or said individual buyers' staff and employees including individual patients, using said devices in said network or networks, who are in places, localities, regions, cities and states in America and other nations, the present invention provides yet a method for computer-automatically and continually retrieving from said processor units, memories and adaptable and expanding SQL databases and displaying said relations, compositions and compilations in said servers which are viewed and used said individual providers, individual buyers and individual patients who are in places, localities, regions, cities and states in America and other nations using said devices and teleconferencing platforms in said network or networks.

Said preferred embodiment provides said adaptable interactive linked Web pages and electronic templates and linked numerous interactive pop-up and drop-down lists are adaptable to computer-automatically generate a first plurality of components of said computerized system for generating individual relations, compositions and compilations of fixed or non-negotiable costs, rates or charges of individual health and health-care services, goods, equipment and medications in said viewing screens by and related to individual providers related to individual medical and surgical specialties or practices and related in related interactive boxes—numbering in several tens of interactive boxes—and information and data on office locations or practices on said individual providers and submitting said relations, compositions and compilations to said processor units, memories and SQL databases from which, subsequently, upon prompting by said individual providers, using said computers, laptops, mobile and wireless communication devices, teleconferencing platforms in said network or networks from anywhere and different and diverse localities, said relations, compositions and compilations are computer-automatically and continually retrieve into said processor units and memories of said servers to be displayed, adapted, adjusted, updated and used in said adaptable interactive linked Web pages and electronic templates and linked numerous interactive pop-up and drop-down lists by said individual providers.

Furthermore, said preferred embodiment provides for continually retrieving and viewing said relations, compositions and compilations in said SQL databases in said viewing screens and, consequently, adjusting, updating, adapting, editing, setting and resetting said relations, compositions and compilations in said processor units, memories and adaptable and expanding SQL databases in said servers by and among said individual providers and/or said individual providers' staff and employees and said individual buyers and/or said individual buyers' staff and employees, who are in same individual localities, places or regions in America or other nations, using said interactive blank boxes in said Servers and/or in said adaptable interactive linked Web pages and electronic templates in said viewing screens. Consequently, effected by said individual providers and/or said individual providers' staff and employees and/or said individual buyers and/or said individual buyers' staff and employees and individual patients, using said devices in said network or networks, who are in places, localities, regions, cities and states in America and other nations, a process for computer-automatically and continually retrieving from said processor units, memories and SQL databases and displaying said adaptable relations, compositions and compilations and related calculations, computations and statistical analyzes and manipulations of said individual relations, compositions and compilations in said servers and displaying said relations, compositions and compilations in said servers and in said viewing screens of said devices and said teleconferencing platforms.

The present invention provides a method for computer-automatically facilitating the generations of said individual ask costs, prices, values and fees related to said individual payables related to individual medical and surgical specialties and practices related to and by said individual providers in same individual localities, places or regions in America or other nations. In said processor units and memories in said server, enabled and effected by and according to said innovative computer programs and software and stored procedures and said SQL Server or computer programs and software infra, based on calculations, computations and statistics, such as, but not limited to, individual standard deviations or variances related to said individual averages, means or medians of said individual ask costs, rates, values and charges also known as asks of said individual providers related to individual medical and surgical specialties and practices and information and data on offices and practices in same individual localities, places or regions in America or other nations, said preferred embodiment enabled and effected a method for computer-automatically guiding and enabling or allowing said keyboarding and/or touch-screening into said individual interactive blank boxes by and among said individual providers, and/or said providers' staff and employees appropriate, consistent, uniform or fair individual ask costs, prices, values and fees related to said individual payables by said individual providers related to individual medical and surgical specialties and practices in in same individual localities, places or regions in America or other nations. Said individual ask costs, rates, values and charges and related adaptable relations, compositions and compilations and related calculations, computations and statistical analyzes and manipulations of said individual relations, compositions and compilations in said servers are computer-automatically retrieved from said processor units, memories and SQL databases and displayed in said servers and/or in said viewing screens of said devices and said teleconferencing platforms for viewing by said people.

Further to supra, therefore, the present invention provides a method for continually retrieving said relations, compositions and compilations in said adaptable and expanding SQL databases into said adaptable interactive linked Web pages and electronic templates in said viewing screens and adjusting, updating, adapting, editing, setting and resetting said individual costs, rates, values and charges related to said individual payables related to said individual providers by said individual providers and/or said individual providers' staff and employees using said interactive blank boxes for generating, enabling, adjusting, updating, adapting, setting and resetting said individual costs, rates, values and charges related to said individual payables related to said individual providers and, consequently, in said processor units, memories and adaptable and expanding SQL databases.

In other words, one of the embodiments of the present invention enables any individual providers—physicians, individual physicians, individual groups of physicians, hospitals, individual hospitals, clinics, individual health-care clinics, facilities, individual health-care facilities, departments or individual departments, and as defined infra, in individual medical and surgical specialties and practices—in places, localities, regions, cities and states in America and other nations to create and generate and, subsequently, adapt or edit individual relations and compositions of said individual fixed or non-negotiable ask costs, rates, values or charges related to said individual payables related and particular to said individual providers in said servers for serving in said pending patent applications in said network or networks.

Furthermore, the present invention provides a method for computer-automatically and continually retrieving from said processor units, memories and SQL databases and displaying or posting said adaptable relations, compositions and compilations and related calculations, computations and statistical analyzes and manipulations of said individual relations, compositions and compilations in said servers in said viewing screens of said devices and said teleconferencing platforms. In other words, effected by said individual providers and/or said individual providers' staff and employees and/or said individual buyers and/or said individual buyers' staff and employees and individual patients, using said devices in said network or networks, who are in places, localities, regions, cities and states in America and other nations, said individual fixed or non-negotiable ask costs, rates, values or charges and any editions related to said individual payables related and particular to said individual providers can be retrieved and viewed by any said individual providers' staff and employees and/or said individual buyers and/or said individual buyers' staff and employees and individual patients.

And effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying or posting said relations, compositions and compilations in said servers and in said viewing screens of said devices and said teleconferencing platforms for the viewing and uses by said individual providers, individual buyers and individual patients to achieve the objectives and goals of the present invention.

The second preferred embodiment of the present invention provides a method for accessing said servers by said individual providers and/or said individual providers' staff and employees and individual buyers, and/or said individual buyers' staff and employees using said devices and said adaptable interactive linked Web pages and electronic templates and numerous linked interactive pop-up and drop-down lists and said interactive blank boxes in said servers and/or in said viewing screens of said devices and/or in said teleconferencing platforms in said network or networks. Therefore, said adaptable relations, compositions and compilations of said individual ask costs, prices, values and fees and related said individual bids and individual counteroffers and related negotiated, settled or set costs, prices, values and fees related to individual payables related to individual providers and related medical and surgical specialities or practices and related individual buyers including individual patients and related non-health and non-health-care services, goods, equipment and related information and data on office, practice, business and residence locations and addresses of said individual providers, individual buyers and individual patients in said processor units, memories and in said adaptable and expanding SQL databases in said servers by said individual providers and/or said individual providers' staff and employees and individual buyers, and/or said individual buyers' staff and employees including individual patients.

This preferred embodiment provides a method for creating and generating successive or sequential individual adaptable relations, compositions and compilations of individual negotiable, variable and adjustable individual costs, rates, values and charges and related negotiated and agreed or set individual costs, rates or charges related to said individual payables or non-health and non-health-care services, goods, equipment related to said individual providers related to individual medical and surgical specialties or practices and related said individual buyers and related information and data on office and practice, business locations and addresses by and between said individual providers, and/or said individual providers' staff and employees, and related individual buyers, and/or said individual buyers' staff and employees, in same individual localities, places or regions in America or other nations, in said processor units, memories and adaptable SQL databases in and manage by said SQL Server in said servers using said adaptable interactive linked Web pages and electronic templates and numerous linked interactive pop-up and drop-down lists and said interactive blank boxes.

The present invention provides said process for accessing said servers by said individual providers and/or said individual providers' staff and employees using said devices and upon prompting by said devices, a process for computer-automatically and continually generating individual electronic templates comprising said individual words, terms and phrases representing said individual payables related to said individual medical or surgical specialties or practices and related individual interactive blank boxes for keyboarding and/or touch-screening individual ask costs, rates, values and charges to relate and compose said relations and compositions of said individual words, terms and phrases and related payables and asks related to said individual providers in said adaptable interactive linked Web pages and electronic templates, enabled and effected by at least HTML, Java Script and AJAX and enabled and effected by and according to said innovative computer programs and software and stored procedures, in said servers and/or in said viewing screens of said devices and teleconferencing platforms. Upon completion of said individual entries of said individual ask costs, rates, values and charges into said individual interactive blank boxes, said relations and compositions related to individual providers are submitted to said processor units and memories from which said relations and compositions are outputted to said adaptable and expanding SQL databases in and manage by said SQL Server enabled and effected by and according to said innovative computer programs and software and stored procedures in said servers.

In addition to supra, said relations and compositions of individual ask costs, rates, values and charges related to individual payables related to all individual providers related by information and data on office and practice locations and addresses such as, but not limited to, by individual zip codes or area codes or individual groups of zip codes or area codes in same individual localities, places or regions in America or other nations in same individual localities, places or regions in America or other nations are computer-automatically and successively or sequentially mathematical calculating, computing and statistically analyzing in said processor units and memories from which said relations and compositions and related calculations, computations and statistical analyzes and manipulations of said individual relations, compositions and compilations are outputted to said adaptable and expanding SQL databases in and manage by said SQL Server enabled and effected by and according to said innovative computer programs and software and stored procedures in said servers, enabled and effected by and according to said innovative computer programs and software and stored procedures in said servers.

For an example, in a mathematical calculation and expression representing many possible mathematical calculations, computations and statistics of a cost, price, value or fee average: A cost, rate, value or charge average for a payable health-care service, representing said individual payables in said medical and surgical specialties and practices=(Σask costs, rates, values or charges for a payable health-care service related to all individual providers in one zip code, a group zip codes, area code or a group of area codes in a region or locality) the number of said all individual providers in said one zip code, a group zip codes, area code or a group of area codes in a region or locality. The product of said one representative computer-automated calculation and applied statistics is an average or mean of ask cost, rate, value or charge related to one said payable health-care service±standard deviations or variances related to or acceptable by said all individual providers related by information and data on office, practice and business locations and addresses such as, but not limited to, individual zip codes, individual area codes, individual groups of zip codes or individual groups area codes in same individual localities, places or regions in America or other nations.

Further to said representation, therefore, said computer-automated process is applied to said individual ask costs, rates, values and charges related to said individual payables related to said individual providers related to individual medical or surgical specialities or practices related to information and data on office, practice and business locations and addresses such as, but not limited to, individual zip codes, individual area codes, individual groups of zip codes or individual groups area codes in same individual localities, places or regions in America or other nations in said processor units and memories and said adaptable and expanding SQL databases in and manage by said SQL Servers coupled to and commanded, enabled and effected by and according to said innovative computer programs and software and stored procedures in said servers.

Said representative mathematical and statistical calculations and expressions represent said process applied to individual asks and also individual bids, individual counteroffers and individual editions of individual negotiated, settled and set costs, rates, values and charges related to said individual payables in said medical and surgical specialties and practices, and related non-health and non-health-care services, goods, equipment and related costs, rates, values and charges, related to and among said individual providers, buyers and patients infra in individual localities, places, cities, states, regions or territories in America or other nations.

To proceed along with description of said individual payables and related, using said one payable health-care service as a representation of millions of said relations and compositions being processed and millions of events in said processor units and memories per unit time, the present invention provides a method for computer-automatically and continually retrieving from said processor units, memories and SQL databases and displaying or posting said representative average or mean of ask cost, rate, value or charge related to one representative said payable health-care service and related interactive blank box in said viewing screens of said devices and said teleconferencing platforms for viewing and use by said individual buyers and/or said individual buyers' staff and employees and individual patients, using said devices in said network or networks, who are in same places, localities, regions as said individual providers or, in other words, all said individual buyers are related to said individual providers by individual same zip codes or area codes or individual groups of zip codes or area codes in same individual localities, places or regions in America or other nations.

Subsequently, said individual buyers generate individual cost, rate, value and charge bids to averages or means of ask costs, rates, values or charges related to individual health-care services by keyboarding and/or touch-screening said individual cost, rate, value and charge bids into said interactive blank boxes and submitting said relations and compositions by said individual buyers, and/or said buyers' staff and employees to said processor units and memories from which said relations and compositions are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures.

Further to supra, in a mathematical calculation and expression representing many possible mathematical calculations, computations and statistics of a cost, price, value or fee average: A cost, rate, value or charge average for a payable health-care service, representing said individual payables in said medical and surgical specialties and practices=(Σbid costs, rates, values or charges for said payable health-care service related to all individual buyers in one zip code, a group zip codes, area code or a group of area codes in a region or locality)÷the number of said all individual buyers in said one zip code, a group zip codes, area code or a group of area codes in a region or locality. The product of said one representative computer-automated calculation and applied statistics is an average or mean of bid cost, rate, value or charge related to one said payable health-care service±standard deviations or variances related to or acceptable by said all individual buyers related by information and data on office and business locations and addresses such as, but not limited to, individual zip codes, individual area codes, individual groups of zip codes or individual groups area.

Using said one payable health-care service as a representation of millions of said relations and compositions being processed and millions of events in said processor units and memories per unit time, the present invention provides a method for computer-automatically and continually retrieving from said processor units, memories and SQL databases and displaying or posting said representative ask and related said one representative average or mean of ask cost, rate, value or charge and related average or mean of bid cost, rate, value or charge related to one representative said payable health-care service and related interactive blank box in said viewing screens of said devices and said teleconferencing platforms for viewing and use by said individual providers and/or said individual providers' staff and employees, using said devices in said network or networks, who are in same places, localities, regions as said individual providers or, in other words, all said individual buyers are related to said individual providers by individual same zip codes or area codes or individual groups of zip codes or area codes in same individual localities, places or regions in America or other nations.

Subsequently, said individual providers generate individual cost, rate, value and charge counteroffers to said individual average or mean bids related to individual payables into said interactive blank boxes and submitting said relations and compositions by said individual providers, and/or said providers' staff and employees to said processor units and memories from which said relations and compositions are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures.

Further to supra, in a mathematical calculation and expression representing many possible mathematical calculations, computations and statistics of a counteroffer cost, price, value or fee average: A counteroffer cost, rate, value or charge average for a payable health-care service, representing said individual payables in said medical and surgical specialties and practices=(Σcounteroffer costs, rates, values or charges for said payable health-care service related to all said individual providers in one zip code, a group zip codes, area code or a group of area codes in a region or locality)÷the number of said all said individual providers in said one zip code, a group zip codes, area code or a group of area codes in a region or locality. The product of said one representative computer-automated calculation and applied statistics is an average or mean of counteroffer cost, rate, value or charge related to one said payable health-care service±standard deviations or variances related to or acceptable by said all individual providers related by information and data on office and practice locations and addresses such as, but not limited to, individual zip codes, individual area codes, individual groups of zip codes or individual groups area.

In this preferred embodiment, said processes are halted and said negotiations by and among said individual providers and individual buyers including individual patients or groups of patients relate by related by information and data on office and practice locations and addresses such as, but not limited to, individual zip codes, individual area codes, individual groups of zip codes or individual groups area are consummated or finalized by said individual counteroffers representing said individual negotiated, settled or set costs, rates, values or charges for individual payables.

Alternatively, the present invention also provides a method for computer-automatically repeating said processes in said processor units and memories enabled and effected by and according to said individual providers and related said individual buyers by said same individual localities, places or regions in America or other nations in said processor units and memories from which said relations and compositions comprising individual asks and related individual bids and counteroffers and related individual standard deviations or variances related to said individual providers and related to said buyers by said same individual localities, places or regions in America or other nations and are outputted to, related to said relations, compositions and compilations in said adaptable and expanding SQL databases in and manage by said SQL Server, enabled and effected by and according to said innovative computer programs and software and stored procedures in said servers.

Further to supra, effected by said individual providers and/or said individual providers' staff and employees, a process for adjusting, setting and resetting said relations, compositions and compilations of said individual costs, rates and charges related to individual payables in interactive linked Web pages and electronic templates, processor units and memories and SQL databases by said individual providers or said physicians in interactive boxes for enabling, adjusting, updating and adapting said individual costs, rates or charges related to said individual providers and related said individual buyers.

And effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying or posting said relations, compositions and compilations in said servers and in said viewing screens of said devices and said teleconferencing platforms for the viewing and uses by said individual providers, individual buyers and individual patients to achieve the objectives and goals of the present invention.

Said preferred embodiment of the present invention provides a method for computer-automatically applying said calculations, computations and statistics such as, but not limited to, said standard deviations or variances for guiding and effecting said generations of said relations and compositions of said individual asks, bids and counteroffers and related negotiated and agreed or set individual costs, rates, values and charges of, by and between said individual providers and individual buyers including individual patients in said processor units, memories and adaptable and expanding SQL databases in said servers.

In other words, whether said statistics are unknown or unlikely applied known to said individual providers, buyers and patients in and during said processes of negotiations or formations of said individual asks, bids, counteroffers and editions by and among said individual providers and individual buyers including individual patients, a method for computer-automatically applying said statistics such as, but not limited to, said individual standard deviations or variances related to said individual asks and related averages, means or medians of said individual asks, bids and counteroffers and editions for computer-automatically guiding and enabling or allowing said keyboarding and/or touch-screening into said individual interactive blank boxes by and among said individual providers, and/or said providers' staff and employees and said related individual buyers, and/or said buyers' staff and employees:
i) said individual ask costs, rates, values and charges generated by said individual providers;
ii) said individual bid costs, rates, values and charges generated by said individual buyers and related to said individual averages, means or medians of said individual ask costs, rates, values and charges; and
iii) said individual counteroffer costs, rates, values and charges generated by said individual providers and related to said individual averages, means or medians of individual cost, rate, value and charge bids
   to achieve the objectives and goals of the present invention. It is to be understood that said method can be supplanted by or involves and uses better method to achieve the objectives and goals within the spirit and the scope of the claims of the present invention.

Nationally or globally, with applications of massive, powerful and configured said processor units and memories in said servers in said cloud computing in said network or networks, said processes are computer-automatically applied to said individual ask costs, rates, values and charges and related bids and related counteroffers and individual negotiated, settled or set costs, rates, values and charges and said editing, setting and resetting of said individual negotiated, settled or set costs, rates, values and charges related to said individual payables, and non-health and non-health-care services, goods, equipment related to said individual buyers and individual patients, related to said individual providers or individual physicians—in said about 85 medical and surgical specialties and practices—related to individual medical or surgical specialities or practices and related individual buyers related to information and data on office, practice and business locations and addresses such as, but not limited to, individual zip codes, individual area codes, individual groups of zip codes or individual groups area codes in same and diverse or different localities, places, regions, cities, states in America and other nations in processor units and memories and said adaptable and expanding SQL databases in and manage by said SQL Servers coupled to and commanded, enabled and effected by and according to said innovative computer programs and software and stored procedures.

It is to be understood that said preferred embodiments of the present invention represent the involvements and uses of any and all appropriate, practical and effective mathematical formulas, equations, calculations, actuaries, statistics such as, but not limited, to sums, averages, means, medians, standard deviations, variances—so stated for abbreviation and convenience in the claims infra—and mathematical and graphic illustrations, analyses, representations and displays commonly applied and used in sciences, medicine, health, health-care and health-care services and information and data on said individual buyers and individual providers from the Internal Revenue Service and from said individual buyers and individual providers and related information and data on office locations, enabled and effected by said innovative computer programs and software and stored procedures coupled to said processor units and memories wherein said mathematical calculations, manipulations and statistical analyses are performed and their adaptations, variations and derivatives to achieve the objectives and goals within the spirit and the scope of the claims of the present invention.

Said mathematical formulas, equations, calculations, actuaries, statistics are present in, applied and implemented by said SQL Server effected and enabled by and according to said innovative computer programs and software and store procedures in said computerized system for generating and managing said individual fixed or non-negotiable costs, rates or charges and for generating and managing said individual negotiable, variable, adjustable and negotiated, agreed or set individual costs, rates, values and charges related to individual payables, and non-health and non-health-care services, goods, equipment, related to and among said individual providers and individual buyers including individual patients in said servers according to the claims of the present invention.

Further to supra, various commercial computer programs and software for generating said appropriate, practical and effective mathematical formulas, equations, calculations, actuaries, statistics such as, but not limited, to sums, averages, means, medians, standard deviations, variances and mathematical and graphic illustrations, analyses, representations and displays are available to be implemented in the present invention to achieve the goals and objectives—one of which is the computer-automatically creating and generating individual said costs, prices, values and fees and related individual payables related to said health-care providers related to medical or surgical specialties or practices and related individual buyers and related information and data on office, practice and business locations and addresses in processor units and memories and said adaptable and expanding SQL databases in and manage by said SQL Servers coupled to and commanded, enabled and effected by and according to said innovative computer programs and software and stored procedures.

Therefore, mathematical formulas, equations, calculations, actuaries and statistics are used and applied in said preferred embodiments to computer-automatically guide, direct and apply said individual asks, bids, counteroffers, negotiated and editions of said costs, prices, values, and fees related to said individual payables and non-health and non-health-care services, goods, equipment by and among said individual providers and/or said individual providers' staff and employees and/or said individual buyers and/or said individual buyers' staff and employees including individual patients, using said devices or teleconferencing platforms in said network or networks, who are in places, localities, regions, cities and states in America and other nations. Further more, individual expenses, overheads, capital and equipment costs and deductions related to individual providers and individual information and data on office and practice locations and addresses in same individual localities, places or regions in America or other nations and said individual buyers' and individual patients' revenues, earnings and/or profits, wages, salaries and/or compensations per time can and will be taken into consideration to achieve the goals and objectives of the present invention.

Further to supra, related to said computer-automatically creating and generating individual said costs, prices, values and fees and related individual payables related to said individual providers related to medical or surgical specialties or practices and related individual buyers and related information and data on office, practice and business locations and addresses, information and data on said individual buyers and individual providers on and related to said individual buyers' and individual providers' expenses, overheads, capital and equipment costs and deductions and related and derivatives per time such as, but not limited to, month, time quarter, semi-annum and annum from the accountants, accounting companies and corporations and the Internal Revenue Service and the like and from said individual buyers and individual providers and related information and data on office, practice and business locations and addresses and said individual buyers' and individual patients' revenues, earnings and/or profits per time are taken into consideration in said computer-automatically creating and generating individual said costs, prices, values and fees and related individual payables related to said health-care providers related to medical or surgical specialties or practices and related individual buyers, enabled and effected by said innovative computer programs and software and stored procedures coupled to said processor units and memories in said servers wherein said mathematical calculations, manipulations and statistical analyses are performed and their adaptations, variations and derivatives to achieve the objectives and goals of the present invention.

In other words, said mathematical formulas, equations, calculations, actuaries and statistics and the like and said expenses, overheads, capital and equipment costs and deductions and related and derivatives revenues, earnings, gains and/or profits, wages, salaries and compensations and the like are used and applied in the establishing or setting of said individual said costs, prices, values and fees related individual payables to be charged by said individual providers and, correspondingly, to be paid by individual buyers as function of said expenses, overheads, capital and equipment costs and deductions and related and derivatives related to said individual providers and providers and revenues, earnings, profits and/or gains and wages, salaries and compensations of individual buyers or individual patients enabled and effected by said innovative computer programs and software and stored procedures coupled to said processor units and memories in said servers in said network or networks for said individual providers related to medical and surgical specialties and practices and individual buyers related to information and data on office, practice and business locations and addresses including, but not limited to, thousands of zip codes or area codes in and throughout America and other nations on earth.

The third preferred embodiment of the present invention provides a method for computer-automatically facilitating the generations of said individual negotiable or adjustable ask costs, prices, values and fees by said individual providers related to said individual payables and related to individual averages, means or medians of said individual ask costs, rates, values and charges related to said individual payables and, subsequently, said individual costs, rates, values and charges generated by said individual buyers related to said individual payables and related to said individual averages, means or medians of individual cost, rate, value and charge bids and, subsequently, said individual costs, rates, values and charges generated by said individual providers related to said individual payables and related to said individual averages, means or medians of individual cost, rate, value and charge counteroffers in said adaptable said adaptable interactive linked Web pages and electronic templates and in said processor units, memories and SQL databases by and among said individual providers and/or said individual providers' staff and employees and/or said individual buyers and/or said individual buyers' staff and employees including individual patients, using said devices or teleconferencing platforms in said network or networks, who are in places, localities, regions, cities and states in America and other nations. In said processor units and memories in said server, based on said calculations, computations and statistics, such as, but not limited to, individual standard deviations or variances related to said individual averages, means or medians of said individual ask costs, rates, values and charges, said individual averages, means or medians of individual cost, rate, value and charge bids and said individual cost, rate, value and charge counteroffers, said preferred embodiment enabled and effected a method for computer-automatically guiding and enabling or allowing said keyboarding and/or touch-screening into said individual interactive blank boxes by and among said individual providers, and/or said providers' staff and employees and said related individual buyers, and/or said buyers' staff and employees.

In other words, one of the embodiments of the present invention enables any individual providers—physicians, individual physicians, individual groups of physicians, hospitals, individual hospitals, clinics, individual health-care clinics, facilities, individual health-care facilities, departments or individual departments, and as defined infra, in individual medical and surgical specialties and practices in same individual localities, places or regions in America or other nations to create and generate and, subsequently, adapt or edit individual relations and compositions of said individual negotiated, settled or set costs, rates, values or charges related to said individual payables related and particular to said individual providers in same individual localities, places or regions in America or other nations in said servers for serving in said pending patent applications in said network or networks.

Uniquely in said network or networks, said individual providers and related individual buyers and related information and data on office locations represented by said preferred embodiments are among many innovative and unique preferred embodiments of the present invention generated and effected numerous said components of said computerized system related to said individual providers and individual buyers and related information and data on office locations in said processor units, memories and SQL databases in and manage by said SQL Server.

The fourth preferred embodiment of the present invention provides a method for setting and resetting or switching the combinations and applications of fixed prices, costs, values and fees and/or said negotiated, settled or set prices, costs, values and fees among said related individual buyers in said functioning and operating computerized systems of payments and related disbursements and barters in said servers by said individual providers comprises a process for continually selecting and applying any said fixed prices, costs, values and fees and/or said negotiated, settled or set prices, costs, values and fees and any combinations of said fixed prices, costs, values and fees and/or said negotiated, settled or set prices, costs, values and fees in said functioning and operating computerized systems of payments and related disbursements and barters in said servers.

In other words, enabled by the present invention and innovative computer programs and software and stored procedures, in numerous settings and circumstances related to hundreds of thousands said individual providers in said about 85 medical and surgical specialties or practices. As a representation of many said possible settings and circumstances, a representative neurologist may use said fixed prices, costs, values and fees with one individual buyer or a plurality of individual buyers and said negotiated, settled or set prices, costs, values and fees with another individual buyer or other plurality of individual health-care buyers. While, a representative endocrinologist may use said fixed prices, costs, values and fees with certain yet another individual buyer or yet other plurality of individual health-care buyers and said negotiated, settled or set prices, costs, values and fees with still another individual buyer or still yet other plurality of individual health-care buyers. While, a representative neurosurgeon may use said fixed prices, costs, values and fees with said individual buyers. While a representative general practitioner may use said fixed prices, costs, values and fees with one individual buyer or a plurality of individual buyers and said negotiated, settled or set prices, costs, values and fees with another individual buyer or other plurality of individual health-care buyers. Said preferred embodiments can be independently achieved by said health-care providers, in processor units and memories and SQL databases in said servers in said network or networks, in diverse and different settings and circumstances and places, locations and regions in America and other nations on earth.

In other words, said individual providers can choose and use any combinations of said fixed prices, costs, values and fees and/or said negotiated, settled or set prices, costs, values and fees to relate to said individual buyers in said functioning and operating computerized systems of payments and related disbursements and barters in said servers. Subsequently, said individual providers can switch to use another one or different combinations of said fixed prices, costs, values and fees and/or said negotiated, settled or set prices, costs, values and fees to related to said individual buyers in said functioning and operating computerized systems of payments and related disbursements and barters in said servers.

Furthermore, yet another example of said preferred embodiment, the present invention enables, for example, individual physicians or individual groups of physicians to switch first said fixed prices, costs, values and fees and/or said negotiated, settled or set prices, costs, values and fees related to first individual localities, places or regions wherein said individual practices of said individual physicians or individual groups of physicians are to second said fixed prices, costs, values and fees and/or said negotiated, settled or set prices, costs, values and fees related to second individual localities, places or regions. For example, a rheumatologist who practiced in a certain zip code, a group of zip codes, area code or a group of area codes, say of a town in Virginia, and used said fixed prices, costs, values and fees and/or said negotiated, settled or set prices, costs, values and fees related to rheumatologists related to said Virginian zip code, a group of zip codes, area code or a group of area codes. Said rheumatologist then relocated to another practice in a different or new zip code, a group of zip codes, area code or a group of area codes, say of a town in New York State, said relocated rheumatologist is computer-automatically switch to use said fixed prices, costs, values and fees and/or said negotiated, settled or set prices, costs, values and fees related to rheumatologists related to said New York State zip code, a group of zip codes, area code or a group of area codes. Concurrently, said information and data on and related to said relocated rheumatologist are computer-automatically and instantly posted to related health-care buyers and individual patients in said server and in said viewing screens of said devices in said network or networks. Said computer-automatic processes are effected by said representative rheumatologist updating his or her information and data on office and practice location and address including, but not limited to, said new zip code or area code.

Analogous to supra, yet the fifth preferred embodiment of the present invention provides the computer-automatic applications of said fixed prices, costs, values and fees and/or said negotiated, settled or set prices, costs, values and fees related to individual providers related to individual medical or surgical specialties and practices related to individual localities, places or regions in America and other nations to individual patients—related to said individual buyers in same or different and diverse settings, localities, places and regions in America and other nations—being provided said individual payables by said individual providers related to individual medical or surgical specialties and practices related to individual localities, places or regions in America and other nations.

For example, an employee residing in Virginia of a company, corporation or employer located in Virginia went on three trips to Florida, Thailand and Shanghai where said employee must see and be treated by an internist, a neurologist and an emergency medicine physician for various ailments and malaise in Florida, Thailand or Shanghai and said internist is related to certain a zip code or a locality comprising of a group of zip codes in Florida, said neurologist is related to certain a zip code or a locality comprising of a group of zip codes in Thailand and said emergency medicine physicians is related to certain a zip code or a locality comprising of a group of zip codes in China. According to one of the preferred embodiments of the present invention, therefore, said Virginian company, corporation or employer will be charged either non-negotiable or fixed ask prices, costs, values and fees for said related individual payables related and particular to physicians related to same individual medical specialties or practices in said individual localities or individual negotiated, settled, agreed or negotiated costs, prices or fees related to said individual payables generated by and between and related and particular to individual providers and related health-care buyers in said individual localities in said servers in said network or networks.

Similarly, one of the preferred embodiments provides a system and method for bartering of said health-care and health-care services and/or related costs, prices and fees for non-health and non-health-care goods and services, and vice versa, related to individual providers and individual health-care buyers and individual patients all of whom are in same, different and diverse settings, localities, places and regions in America and other nations enabled and effected by said process for computer-automatically creating and continually generating SQL relations and compilations of said information and data on office locations on said individual buyers and said information and data on office locations on said individual providers and related adjustable individual costs, prices, values and fees and related individual payables or related non-health and non-health-care goods and services related to said individual providers and said individual health-care buyers both of whom are in different and diverse settings, localities, places and regions in America and other nations viewable, adjustable and managing by said individual providers and said individual health-care buyers viewable, adjustable and managed by and among said individual providers and said individual health-care buyers.

Yet another preferred embodiment of the present invention provides a system and method for computer-automatically and continually creating and generating individual desirable or suitable relations, compositions and compilations among said individual providers, individual buyers and individual patients in said processor units, memories and SQL databases upon prompting said servers by individual providers, individual buyers and/or individual patients using adaptable interactive linked Web pages and electronic templates and linked numerous interactive pop-up and drop-down lists and interactive blank boxes for generating instructions or queries to said servers for responding by creating and generating said individual desirable or suitable relations, compositions and compilations for affecting and effecting individual searches, finds, trades, exchanges and/or purchases of said individual payables and said individual non-health and non-health-care services, goods, equipment by and among said among said individual providers, individual buyers and individual patients in said network or networks.

With said prototype of the present invention, said preferred embodiments and their derivatives of the present invention are coupled to and computer-automatically and continually implemented and served in the functioning and operating computerized systems of payments and related disbursements and barters in a functioning and operating computer server or servers in said pending patent applications such as, but not limited to, Ser. No. 12/592,714 filed Dec. 2, 2009 entitled Health-care Exchange IV, Ser. No. 12/584,718 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians for managing, effecting and controlling said costs, expenses, payments, compensations and revenues of, by and among said buyers and related providers in a functioning and operating servers in a network or networks of said servers, computers, laptops, mobile and wireless communication devices, teleconferencing platforms and the Internet being used by said buyers and providers, enabled and effected by and according to said innovative computer programs and software and stored procedures in said servers in said network or networks.

Furthermore, said preferred embodiments of the present invention are applicable to said barters since individual non-health and non-health-care goods and services provided by said individual buyers and individual patients are related to individual costs, prices, monetary values, costs and fees which are related to said individual costs, rates or charges related to said individual payable and related said individual providers.

Said individual non-health and non-health-care goods and services can and will be related to individual costs, prices or fees assigned to said individual non-health and non-health-care goods and services and/or related to individual payable health and health-care services, tests, goods, equipment, and medications and/or related individual costs, prices or fees assigned to said individual payables related to physicians, individual physicians, individual groups of physicians, individual hospitals, individual health-care clinics, individual health-care facilities or individual departments in individual localities, places, regions, cities and/or states in America and/or other nations. Said relations and compilations are represented by relations and compilations of individual SQL keys I in said SQL databases in and manage by said SQL Server. Thus, in other words, said barter system encompasses a few preferred embodiments of the present invention wherein said non-health and non-health-care goods, equipment and services and related individual costs, prices or fees and said health and health-care services, tests, goods, equipment and medications and related individual costs, prices or fees can be transacted in the present invention. In other words, first, said individual non-health and non-health-care goods, equipment and services may be bartered for said individual health and health-care services, tests, goods, equipment and medications in said servers and computers and devices in said network or networks. Second, individual costs, prices or fees related to non-health and non-health-care goods, equipment and services can be exchanged with or traded for—exchanges or conversions of international currency rates accounted—individual costs, prices or fees related and said health and health-care services, tests, goods, equipment and medications in said servers and computers and devices in said network or networks. And any and all combinations or permutations of supra in said servers and computers and devices in said network or networks.

Said preferred embodiments and their derivatives are applicable to and for all said individual providers and related individual buyers and individual patients in America and other nations on earth and have taken diverse and different currencies in all nations such as, but not limited to, various types of dollars including American, Canadian, Australian, Singapore and Hong Kong dollars, euro, pounds, krone, franc, yuan, yen, baht, ruble, rupee, peso, shekel, goods and services and exchanges into considerations and executions in said network or networks.

It is to be understood that said systems and methods can be supplanted by or involves and uses better systems and methods to achieve the objectives and goals within the spirit and the scope of the claims of the present invention.

It is understood that the terms health-care, health care and healthcare have the same meaning and application and that the terms computer server, computer servers, server and servers—which also broadly imply server blades and virtual servers and similar, same or equivalent hardware and equipment configurations such as those sold by VMware, Hewlett Packard, and IBM, and their derivatives, and being used by many large American and foreign corporations such as, but not limited to, Amazon.com, Rackspace Cloud, Salesforce, Skytap, Microsoft and Google, Huawei, Cisco, Fujitsu, DC Wirenet, Dell, Red Hat, Hitachi and NetApp for cloud computing and the like, have the same meaning and application and are implemented for implementing and effecting said pending patents and the present invention. Furthermore, computer-automated, computer-automatically, computer-generated and computer-enabled used herein mean computer server-automated, computer server-automatically, computer server-generated and computer server-enabled. Also, it is understood that the term software is used herein as singular and pleural.

It is to be understood that the preferred embodiments of the present invention and adaptations, variations and improvements apply to all physicians, including other healthcare providers as described herein, in America and other nations and territories and information and data on all diagnoses, diseases and disorders and related categories herein in about 85 medical and surgical specialties or practices.

Although it has been described in pending earlier patent applications, said data and information are words, terms, word and term headers and topics and subjects as shown above such as, but not limited to, Evaluation, Chief Complaints, Review of Systems, Diagnoses, Differential Diagnoses, Physical Examinations, Medications, Treatments, Surgeries, etc., phrases, synonyms, codes, numbers, sentences, texts and graphic, etc. used and use by physicians in all—approximately 85—medical and surgical specialties and practices to describe and document data and information on diseases, illnesses, disorders, health and health-care of patients and health-care services. At least Java Script and AJAX are used to support said templates, lists and menus.

The method, processes, system, protocols, matters, products, functions and related and derivatives of the present invention are implemented and effected by an innovative computer software and program invented and developed by the present patent applicant which were filed with and are stored in the Library of Congress in Washington, D.C. The present invention uses also the commercially available computer software (plural), programs and computer languages and server operating systems such as, but not limited to, those made and sold by Microsoft Corporation such as, but not limited to, Microsoft Windows Server 2008 and their derivatives, and by nascent computer operating system by Google, and SQL such as, but not limited to Microsoft SQL Server 2008 R2 and derivatives, MySQL and the like, Internet Explorer, Web browsers, Web server, Apache, Microsoft IIS, Visual Studio and .Net, Notepad, Wordpad and .txt programs and their derivatives and the like and related and their database, databases and derivatives, other computer corporations' and companies' programs, languages, codes and databases and their derivatives which are commonly and routinely used by computer engineers and programmers such as, but not limited to, PHP 5.2.14 and the like and derivatives, PERL, C languages, such as, but not limited to, C, C+, C++, C#, JAVA, Java Script, AJAX, HTML, XHTML and the like and related and their derivatives. Other security software are such as, but not limited to, encryption-decryption of the information and data infra and their derivatives and products, processes and software, Firewall, anti-viral and related, Secure Sockets Layer (SSL) or Transport Layer Security (TLS) and related and the like and their derivatives.

Applying and using teleconferencing technologies and platforms and their derivatives in said network or networks of computer servers, computers, laptops and mobile and wireless communication and teleconferencing-enabled devices, the preferred embodiments of the present invention are applied and used by health-care buyers, individual health-care buyers or individual groups of health-care buyers, consumers and governments and physicians, individual physicians or individual groups of physicians, hospitals and health-care facilities and their employees and staff members in same and diverse and different settings and locations and all different time zones all over the world. In other words, the preferred embodiments of the present invention can be and are enabled and effected by numerous commercially available teleconferencing technologies and products provided by, but not limited to, www.webex.com by Cisco Systems, Inc., www.gotomeeting.com by Citrix Online, L.L.C., Microsoft Office Live Meeting by Microsoft Corporation and Adobe Acrobat Connect by Adobe Systems, Inc. and their derivatives and the like, and various companies or corporations to enable said individuals in various and different settings and locations to teleconference, effect and use said preferred embodiments in said network or networks via the Internet to achieve the goals and objectives of the present invention.

The standard commercial hardware and equipment being used in the TCP/IP networks and the like or equivalence such as, but not limited to, the Internet commerce are implemented and deployed per standard industrial practices and use hardware and equipment such as, but not limited to, computer servers and computers such as numerous HP and IBM servers, HP and Dell computers, Cisco routers and related and their derivatives, and various equipment including modems sold, lease, own and operate by cable companies such as, but not limited to, Time Warner and Optimum Online in New York, etc. Further to supra, currently, various server blades and various hardware and equipment configurations, virtual servers such as those sold by VMware, HP and IBM, and their derivatives being used by many large American corporations are set up and implemented for implementing said pending patents and the present invention. HP servers—see www.hp.com for details of the server hardware and internal design—and similar Dell servers—see www.dell.com for details of the server hardware and internal design—used by the present patent applicant as the hardware wherein the computer programs and software(s) mentioned herein operated. It is to be understood that said pending patents and related applications and the present invention enabled and effected by said equipment, devices, computer programs and software and technologies birthed said Cloud Healthcare Exchange for achieving and fulfilling said goals and objectives, enterprises and endeavors in said pending patents and the present invention.

It is to be understood that physicians, individual physicians, individual groups of physicians, hospitals and health-care facilities described herein also included all health and health-care providers providing health, health-care, health-care services and supports and manufacturers, producers, companies and corporations and sellers of medications, drugs and pharmaceuticals related to people. Furthermore, individual health-care buyers or individual health-care consumers are or represent, but not limited to, individual companies, corporations, employers, patients, businesses, operations, various municipalities, cities, towns, states, organizations, entities, departments, institutions and individual groups or cooperatives of said people purchasing, using and consuming said health, health-care and health-care services and goods, equipment, medications and pharmaceuticals for their employees, retirees and their dependents or for themselves. Said governments represent governments of any and all nations in the world.

Further to supra, said preferred embodiments also encompasses and enabled the negotiations and barters of said costs, prices, values and fees and related payables and related non-health and non-health-care services and goods, equipment of and between government and various governmental agencies, departments and institutions and other governments of America and other nations and said individual providers in said network or networks.

Said any and all successive calculations, computations and manipulations and related processes and outcomes are computer-automatically achieved in said processor units and memories and SQL databases and retrieved and displayed in said adaptable interactive linked Web pages and electronic templates and numerous linked interactive pop-up and drop-down lists in the teleconferencing platforms and in said servers and related equipment and devices and retrieved and viewed in said viewing screens of said computers, laptops, mobile and wireless communication devices including smartphones and/or retrieved and viewed in said viewing screens of said computers, laptops, mobile and wireless communication devices including smartphones.

It is to be understood that one of the preferred embodiments of the present invention involves the use and application of information and data on information and data on office locations and addresses or demography on or of physicians, individual physicians, individual groups of physicians, individual hospitals, individual health-care clinics, individual health-care facilities or individual departments, health-care buyers including patients, individual health-care buyers including individual patients, individual groups of health-care buyers including individual groups of patients and individual governments and agencies, departments and institutions are such as, but not limited to, medical and surgical specialties and practices, zip codes, country codes, city and state codes, area, region and territorial codes and related addresses and the like and derivatives, biological and genomic information and data, names, email addresses, works, careers, jobs, enterprises, businesses, trades and the like, salutations on said people and institutions linking or relating said people and said services, goods, costs, prices, values and fees, individual payables and non-health-care services and goods will be used and applied in said processor units, memories and SQL databases to achieve the objectives and goals of the present invention.

Further to supra, one of the preferred embodiments of the present invention encompasses all elements and components of said information and data on office locations on said people. For example, all zip codes—thousands of zip codes in America alone—or area codes and their derivatives and related, etc., for America and other nations are generated by said individual providers, individual buyers and/or staff and employees and individual patients, using said devices and/or teleconferencing platforms and related devices, in their submissions of said information and data on office locations to said processor units, memories and SQL databases in said servers where in said SQL relations and compilations of said elements and components related to individual SQL keys are computer-automatically created and generated in said processor units, memories and SQL databases in said SQL Server enabled and effected by said innovative computer programs and software and stored procedures.

In other words, the present invention provides for the use of any elements or components of said information and data on office locations of said people in said network or networks. Using zip codes as a representation, any and all zip codes present in said submissions of said information and data on office locations by people can be applied in said preferred embodiments enabled and effected by enabled and effected by said innovative computer programs and software and stored procedures. However, said innovative computer programs and software and stored procedures can be and are designed to enable and effect computer-automatically use and apply said zip codes—thousands of zip codes in America alone—in any and all orders such as, but not limited to, individual zip codes, individual groups of zip codes and any combinations thereof in America. Similarly, said preferred embodiments apply to people in other nations. In other words, individual interactions of and among said individual providers and individual buyers, according to the claims infra, can be and are dictated by said orders representing one of the preferred embodiments of the present invention.

As stated supra, it is to be understood that said preferred embodiments are coupled to the innovative systems and methods provided by said earlier pending patent applications such as, but not limited to, Ser. No. 12/592,714 filed Dec. 2, 2009 entitled Health-care Exchange IV, Ser. No. 12/584,718 filed Sep. 11, 2009 entitled the Health-care exchange III, Ser. No. 12/381,654 entitled the Adaptable Compositions of Health Information, Ser. No. 12/321,141 entitled the Best system of health and health-care data management Ser. No. 12/069,409 entitled the Filing of health and health-care data, Ser. No. 12/322,529 entitled the Healthcare exchange II, Ser. No. 12/080,433 filed Apr. 3, 2008 entitled Healthcare exchange, Ser. No. 12/072,097 filed Feb. 25, 2008 entitled a Method of empowering owners of health-care resources, and Ser. No. 11/242,461 filed Oct. 4, 2005 entitled a Perfect system of compensations for physicians which are the functioning and operating computerized systems of payments and related disbursements and barters in a functioning and operating computer server or servers.

It is to be understood that one of the preferred embodiments of the present invention provides computer-generated individual words, terms and phrases representing said individual payables in and related to all—approximately 85—medical and surgical specialties and practices of physicians and health-care providers from relations, compositions and compilations of said words, terms and phrases in said SQL databases in said servers and computer-enabled displays of individual words, terms and phrases related to individual medical and surgical specialties and practices in said adaptable interactive linked Web pages and electronic templates and numerous linked interactive pop-up and drop-down lists, enabled and effected by at least HTML, Java Script and AJAX and enabled and effected by and according to said innovative computer programs and software and stored procedures, in said servers and/or said viewing screens of said devices and teleconferencing platforms in said network or networks. Thus, said preferred embodiment provides said computer-generated individual templates comprising said individual words, terms and phrases related to said individual medical or surgical specialties or practices related to individual providers and related interactive blank boxes for keyboarding and/or touch-screening individual costs, rates, values and charges to relate and compose said relations and compositions of said individual words, terms and phrases related to said computer-generated individual words, terms and phrases by and among said individual providers and individual buyers and individual patients.

It is to be understood that one of the preferred embodiments of the present invention teaches said keyboarding, touch-screening and interactive blank boxes in said viewing screens, it will be appreciated by those skilled in the art that their adaptations, variations and derivatives including voice inputs and related speech recognition technologies and devices may be applied and engaged to achieve the objectives and goals of the present invention without departing from the spirit and the scope of the claims of the present invention.

Although various preferred embodiments of the present invention have been described, it will be appreciated by those skilled in the art that their adaptations and variations said preferred embodiments including intensive-human-labored or machines-and-human-labored systems and methods may be made or incorporated into said preferred embodiments to achieve the objectives and goals of the present invention without departing from the spirit and the scope of the claims of the present invention.

As described in said brief description and the claims infra, it is to be understood that the present invention can and will derive, evolve and generate numerous preferred embodiments related or independent of said representative preferred embodiments to achieve the objectives and goals of the present invention without departing from the spirit and the scope of the claims of the present invention.

Although various preferred embodiments of the present invention have been described, it will be appreciated by those skilled in the art that their adaptations including various combinations of said preferred embodiments and variations, expansions and derivatives may be made to achieve the objectives and goals of the present invention without departing from the spirit and the scope of the claims of the present invention.

1. A computerized system for generating and managing adaptable and expanding relations, compositions and compilations of individual non-negotiable or fixed ask costs, prices, values or fees and related individual payable health and health-care services, tests, goods, equipment and medications henceforth individual payables generated by and related to physicians, individual physicians, individual groups of physicians, hospitals, individual hospitals, clinics, individual health-care clinics, facilities, individual health-care facilities, departments or individual departments henceforth collectively known as individual providers and relations, compositions and compilations of individual negotiable or adjustable ask costs, prices, values and fees related to individual payables related to individual providers and related cost, price, value and fee bids and related cost, price, value and fee counteroffers and related settled, agreed or negotiated costs, prices, values and fees of, related to and among said individual providers and health-care buyers, individual health-care buyers, individual groups of health-care buyers or individual governments henceforth collectively known as individual buyers related to said individual payables and non-health and non-health-care goods and services generated and composed by and between said individual providers and related individual buyers in same individual localities, places or regions in America or other nations or in different and diverse settings, localities, places and regions in America and other nations in adaptable and expanding SQL databases in and manage by a SQL Server in a operating and functioning computer server or servers henceforth servers for enabling, generating and managing said relations, compositions and compilations related to said individual providers and individual buyers for enabling and effecting the applications of said relations, compositions and compilations for managing human resources and managing and controlling health-care funds and resources including costs of individual payables of and for said individual providers and individual buyers and individual patients in said servers in a network or networks of said servers, and computers, laptops, mobile and wireless communication devices, teleconferencing platforms and related devices and the Internet henceforth devices comprises:
said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and said innovative computer programs and software and stored procedures coupled to, communicating with and commanding said SQL Server, processor units and memories, adaptable interactive linked Web pages and electronic templates and numerous linked interactive pop-up and drop-down lists in said viewing screens, computer programs or software for calculating and statistically calculating and manipulating said costs, prices, values and fees, teleconferencing platforms comprising teleconferencing technologies and related devices and equipment including video equipment, and said devices including smartphones for repetitively and continually accessing said servers and generating, adjusting, updating, adding, adapting, setting and resetting said relations, compositions and compilations in said processor units, memories and adaptable and expanding SQL databases by, among or between said individual buyers and individual providers comprising keyboards and viewing screens including touch-enabled viewing screens or touchscreens, enabled by Web browsers and said Web server in said network or networks;
said adaptable and expanding SQL databases in and managed by said SQL Server created and enabled and effected by and according to said innovative computer programs and software and stored procedures;
said adaptable interactive linked Web pages and electronic templates and numerous linked interactive pop-up and drop-down lists in said viewing screens, enabled by JavaScript, AJAX and HTML, innovative computer programs and software, stored procedures, Web browsers and Web server, comprising individual payables in medical and surgical categories of Evaluations, Laboratories, Imaging, Body Fluid Tests and Tissues Examinations, Medications, Devices, Equipment, Procedures, Treatments, Surgeries, Recommendations, Guidelines and Referrals related to individual diagnoses in medical and surgical specialties and practices related to said individual providers related to said medical and surgical specialties and practices and related information and data on office and practice locations and addresses such as, but not limited to, zip codes or area codes and related said relations and compositions of said costs, prices, values and fees and related bids and counteroffers related to said individual providers and individual buyers including individual patients and related interactive blank boxes for keyboarding and/or touch-screening said individual costs, prices, values and fees and related bids and counteroffers and related information and data on office, practice, business and residence locations and addresses for submitting to said processor units and memories and said adaptable and expanding SQL databases in and manage by said SQL Server and said interactive blank boxes for generating, adjusting, updating, adapting, editing, setting and resetting said relations, compositions and compilations related to said individual providers and related individual buyers and individual patients in said processor units, memories and said SQL databases;
said innovative computer programs and software and stored procedures for:
i) creating and generating said adaptable interactive linked Web pages and electronic templates and numerous linked interactive pop-up and drop-down lists comprising said individual payables and interactive blank boxes;
creating and generating said adaptable and expanding SQL databases;
ii) creating, generating, adapting and expanding said adaptable and expanding relations, compositions and compilations in said adaptable interactive linked Web pages and electronic templates and in said processor units, memories and SQL databases;
iii) calculating, computing, statistically analyzing said individual ask costs, prices, values and fees and related said bids and counteroffers related to said individual payables or non-health and non-health-care services, goods, equipment related to said individual providers and individual buyers including individual patients and related information and data on offices, practices, businesses and wages, salaries and compensations and on office, practice, business locations and addresses and related individual localities, places and regions in America and other nations;
iv) applying calculations, computations and statistics on said relations, compositions and compilations for guiding and effecting said relations, compositions and compilations in said processor units and memories;
v) retrieving from said processor units, memories and SQL databases and displaying said adaptable relations, compositions and compilations and related calculations, computations and statistical analyzes and manipulations of said individual relations, compositions and compilations in said servers in said servers and in said viewing screens of said devices and said teleconferencing platforms;
vi) setting and resetting or switching and applying various combinations and applications of said fixed prices, costs, values and fees and/or said negotiated, settled or set prices, costs, values and fees among said related individual buyers in said functioning and operating computerized systems of payments and related disbursements and barters in said servers by said individual providers;
vii) adjusting, editing, setting and resetting said relations, compositions and compilations of said individual costs, rates and charges related to individual payables in said processor units and memories and SQL databases by said individual providers or said individual physicians and/or said individual providers' or physicians' staff and employees;
viii) computer-automatically applying said fixed prices and/or said negotiated, settled or set prices, costs, values and fees related to individual providers related to individual medical or surgical specialties and practices related to individual localities, places or regions in America and other nations to individual patients—related to said individual buyers in same or different and diverse settings, localities, places and regions in America and other nations—being provided said individual payables by said individual providers related to individual medical or surgical specialties and practices related to individual localities, places or regions in America and other nations; and
ix) establishing relations and compositions of said fixed prices, costs, values and fees and/or said negotiated, settled or set prices, costs, values and fees and related non-health and non-health-care goods and services in said processor units, memories and SQL databases and generating relations and compositions of said individual payables related to said fixed prices, costs, values and fees and/or said negotiated, settled or set prices, costs, values and fees related to said individual providers and related individual patients or related said individual patients related to said individual buyers.

2. In a computerized system for generating and managing adaptable and expanding relations, compositions and compilations of individual non-negotiable or fixed ask costs, prices, values or fees and related individual payable health and health-care services, tests, goods, equipment and medications henceforth individual payables generated by and related to physicians, individual physicians, individual groups of physicians, hospitals, individual hospitals, clinics, individual health-care clinics, facilities, individual health-care facilities, departments or individual departments henceforth collectively known as individual providers and relations, compositions and compilations of individual negotiable or adjustable ask costs, prices, values and fees related to individual payables related to individual providers and related cost, price, value and fee bids and related cost, price, value and fee counteroffers and related settled, agreed or negotiated costs, prices, values and fees related to and among said individual providers and health-care buyers, individual health-care buyers, individual groups of health-care buyers or individual governments henceforth collectively known as individual buyers related to said individual payables and non-health and non-health-care goods and services generated and composed by and between said individual providers and related individual buyers in same individual localities, places or regions in America or other nations or in different and diverse settings, localities, places and regions in America and other nations in adaptable and expanding SQL databases in and manage by a SQL Server in a operating and functioning computer server or servers henceforth servers for enabling, generating and managing said relations, compositions and compilations related to said individual providers and individual buyers for enabling and effecting the applications of said relations, compositions and compilations for managing human resources and managing and controlling health-care funds and resources including costs of individual payables of and for said individual providers and individual buyers in said servers in a network or networks of said servers, and computers, laptops, mobile and wireless communication devices, teleconferencing platforms and related devices and the Internet henceforth devices, a method for computer-automatically generating, transacting, negotiating, managing and controlling said asks, bids, counteroffers and related negotiated costs, prices, values and fees related payables and non-health and non-health-care goods and services of, for, by and between or among said individual providers and individual buyers and individual patients, who are in places, localities, regions, cities and states in America and other nations, in said servers enabled and effected by and according to the innovative computer programs and software and stored procedures in said servers in said network or networks comprises:
a process for operating said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and said innovative computer programs and software coupled to, communicating with and commanding said SQL Server, processor units and memories, adaptable interactive linked Web pages and electronic templates and numerous linked interactive pop-up and drop-down lists in said viewing screens, a plurality of components of said computerized system and functioning and operating computerized systems of payments and related disbursements and barters, teleconferencing platforms comprising teleconferencing technologies and related devices and equipment, and said devices for accessing said servers and generating, adjusting, updating, adding, adapting, setting and resetting said adaptable and expanding SQL databases by and among said individual health-care buyers and individual health-care providers comprising keyboards and viewing screens including touch-enabled viewing screens or touchscreens, enabled by Web browsers and said Web server in said network or networks;
a process for creating, implementing and applying said innovative computer programs and software and stored procedures coupled to said processor units, memories and SQL Server in said servers;
a process for computer-automatically and continually generating adaptable interactive linked Web pages and electronic templates and numerous linked interactive pop-up and drop-down lists in said viewing screens, enabled by JavaScript, AJAX and HTML, innovative computer programs and software, stored procedures, Web browsers and Web server, comprising individual payables in medical and surgical categories of Evaluations, Laboratories, Imaging, Body Fluid Tests and Tissues Examinations, Medications, Devices, Equipment, Procedures, Treatments, Surgeries, Recommendations, Guidelines and Referrals related to individual diagnoses in medical and surgical specialties and practices related to said individual providers related to said medical and surgical specialties and practices and related information and data on office and practice locations and addresses such as, but not limited to, zip codes or area codes and related said relations and compositions of said costs, prices, values and fees and related bids and counteroffers related to said individual providers and individual buyers including individual patients and related interactive blank boxes for keyboarding and/or touch-screening said individual costs, prices, values and fees and related bids and counteroffers and related information and data on office, practice, business and residence locations and addresses for submitting to said processor units and memories and said adaptable and expanding SQL databases in and manage by said SQL Server and said interactive blank boxes for generating, adjusting, updating, adapting, editing, setting and resetting said relations, compositions and compilations related to said individual providers and related individual buyers and individual patients in said processor units, memories and said SQL databases;
a process for creating, generating, implementing and applying said adaptable and expanding SQL databases by said innovative computer programs and software and stored procedures coupled to said processor units, memories and SQL Server in said servers;
a process for computer-automatically creating, generating and maintaining adaptable relations, compositions and compilations of said information and data on said individual providers, said individual buyers and individual patients and related office, practice, business and residence locations and addresses on and related to said individual providers, buyers and patients related to medical or surgical specialties or practices and related said individual costs, prices, values and fees and related bids, counteroffers and negotiated or settled or set costs, prices, values and fees related to individual payables and related non-health and non-health-care goods and services by and among said individual buyers, individual patients and said individual providers using said devices for accessing said servers;
a process for computer-automatically creating and generating individual adaptable relations, compositions and compilations of said individual costs, prices, values and fees and related individual payables related to individual providers related to individual medical and/or surgical specialities or practices and related information and data on office and practice locations and addresses in said processor units, memories and in said adaptable and expanding SQL databases in said servers;
a process for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers and related settled, agreed or negotiated costs, prices, values and fees related to individual payables and related non-health and non-health-care goods and services by and among said individual buyers, individual patients and said individual providers using said devices for accessing said servers;
a process for computer-automatically creating and generating adaptable relations, compositions and compilations of said individual costs, prices, values and fees and related said bids and counteroffers and related individual payables related to individual providers and related medical and surgical specialities or practices and related individual buyers and related non-health and non-health-care services, goods, equipment and related information and data on office, practice, business and residence locations and addresses of said individual providers and individual buyers in said processor units, memories and in said adaptable and expanding SQL databases in said servers;
a process for computer-automatically and sequentially calculating, computing, statistically analyzing said individual ask costs, prices, values and fees and related said bids and counteroffers related to said individual payables or non-health and non-health-care services, goods, equipment in said processor units and memories from which said calculations, computations and statistics on and related to said individual ask costs, prices, values and fees and related said bids and counteroffers are outputted to, relate and compiled in said adaptable and expanding SQL databases in said servers;
a process for computer-automatically applying said calculations, computations and statistics related to said individual providers and related individual buyers and individual patients and related said information and data on office, practice, business and residence locations and addresses for guiding and effecting said generations of said relations and compositions of said individual bids and counteroffers and related negotiated and agreed or set individual costs, rates, values and charges of, by and between said individual providers and individual buyers including individual patients in said processor units, memories and adaptable and expanding SQL databases;
a process for continually retrieving said relations, compositions and compilations in said adaptable and expanding SQL databases into said adaptable interactive linked Web pages and electronic templates in said viewing screens and adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees using said interactive blank boxes for generating, enabling, adjusting, updating and adapting said individual costs, rates or charges related to said individual providers and related said individual buyers including individual patients and, consequently, in said processor units, memories and adaptable and expanding SQL databases;
a process for setting and resetting or switching and applying various combinations and applications of said fixed prices, costs, values and fees and/or said negotiated, settled or set prices, costs, values and fees among said related individual buyers in said functioning and operating computerized systems of payments and related disbursements and barters in said servers by said individual providers;
a process for continually adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees;
a process for computer-automatically applying said fixed prices, costs, values and fees and/or said negotiated, settled or set prices, costs, values and fees related to individual payables in individual medical or surgical specialties or practices related to individual providers related to individual patients—related to said individual buyers in same or different and diverse settings, localities, places and regions in America and other nations—who are provided said individual payables by said individual providers in individual localities, places or regions in America and other nations;
a process for computer-automatically creating and generating adaptable relations, compositions and compilations of individual costs, prices, values and fees related to information and data on said individual non-health and non-health-care services, goods, equipment related to individual buyers and individual patients and related individual providers and related said individual ask costs, prices, values and fees related to said individual payables in America and other nations in said servers in said network or networks; and
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

3. The method according to claim 2 wherein said process for computer-automatically creating, generating and maintaining adaptable relations, compositions and compilations of said information and data on said individual providers, said individual buyers and individual patients and related office, practice, business and residence locations and addresses on and related to said individual providers, buyers and patients related to medical or surgical specialties or practices and related said individual costs, prices, values and fees and related bids, counteroffers and negotiated or settled or set costs, prices, values and fees related to individual payables and related non-health and non-health-care goods and services by and among said individual buyers, individual patients and said individual providers using said devices for accessing said servers comprises:
a process for generating relations and compositions on information and data on said individual providers including office and practice locations and addresses on said individual providers and related individual medical or surgical specialties or practices, related said individual negotiable or adjustable ask costs, prices, values and fees, related said cost, price, value and fee counteroffers and said settled, agreed or negotiated costs, prices, values and fees related to individual payables by said individual providers and/or said individual providers' staff and employees using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled in said adaptable and expanding SQL databases in and manage by said SQL Server in said servers;
a process for generating relations and compositions on information and data on said individual buyers including office and business locations and addresses on said individual buyers and related said individual cost, price, value and fee bids, related to said settled, agreed or negotiated costs, prices, values and fees related to said individual payables, and non-health-care goods and services and related costs, prices, values and fees by said individual buyers and/or said individual buyers' staff and employees including individual patients using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled with related said individual providers' relations, compositions and compilations in said adaptable and expanding SQL databases;
a process for generating relations and compositions on information and data on said individual patients including residence locations and addresses on said individual patients related to said individual buyers and related individual buyers' office and business locations and addresses and, if wherever applicable, and non-health-care goods and services and related costs, prices, values and fees related to said individual patients using said adaptable interactive linked Web pages and electronic templates and linked numerous interactive pop-up and drop-down lists and interactive blank boxes in said viewing screens of said devices for generating and submitting said information and data via the Internet to said processor units, memories from which said relations and compositions on office and practice locations are computer-automatically outputted to, related to individual SQL keys and compiled with related said individual providers' and individual buyers' relations, compositions and compilations in said adaptable and expanding SQL databases; and
effected by said individual providers and/or said individual providers' staff and employees and/or said individual buyers and/or said individual buyers' staff and employees including individual patients using said interactive blank boxes for generating, enabling, adjusting, editing, updating, adapting, setting and resetting said relations, compositions and compilations in said viewing screens of said devices or in said teleconferencing platforms in said network or networks, a process for retrieving said relations, compositions and compilations in said adaptable and expanding SQL databases into said adaptable interactive linked Web pages and electronic templates in said viewing screens and adjusting, updating, adapting, editing, setting and resetting, if enabled and effected by and according to said innovative computer programs and software, said relations, compositions and compilations and, consequently, in said processor units, memories and adaptable and expanding SQL databases.

4. The method according to claim 2 wherein said process for computer-automatically creating and generating individual adaptable relations, compositions and compilations of said individual costs, prices, values and fees and related individual payables related to individual providers related to individual medical and/or surgical specialities or practices and related information and data on office and practice locations and addresses in said processor units, memories and in said adaptable and expanding SQL databases in said servers comprises:
a process for computer-automatically and continually generating adaptable interactive linked Web pages and electronic templates and numerous linked interactive pop-up and drop-down lists and said interactive blank boxes in said viewing screens of said devices and in said teleconferencing platforms;
said process for accessing said servers by said individual providers and/or said individual providers' staff and employees using said devices and upon prompting by said devices, a process for computer-automatically and continually generating individual electronic templates comprising said individual words, terms and phrases related to said individual payables related to said individual medical or surgical specialties or practices and related individual interactive blank boxes for keyboarding and/or touch-screening individual ask costs, rates, values and charges to relate and compose said relations and compositions of said individual words, terms and phrases and related payables in said adaptable interactive linked Web pages and electronic templates for generating relations, compositions and compilations, enabled and effected by at least HTML, Java Script and AJAX and enabled and effected by and according to said innovative computer programs and software and stored procedures, in said servers and said viewing screens of said devices and teleconferencing platforms in said network or networks;
a process for keyboarding and/or touch-screening said numerous linked interactive pop-up and drop-down lists to create and generate individual relations and compositions on said individual costs, rates, values or charges related to said individual payables related to said individual providers related to individual medical or surgical specialties or practices related to information and data on office and practice locations and addresses such as, but not limited to, individual zip codes or area codes in said interactive blank boxes and submitting said relations and compositions by said individual providers and/or said individual providers' staff and employees to said processor units and memories from which said relations and compositions are outputted to, related to individual SQL keys and compiled in said adaptable and expanding SQL databases;
a process for continually retrieving said relations, compositions and compilations in said adaptable and expanding SQL databases into said adaptable interactive linked Web pages and electronic templates in said viewing screens and adjusting, updating, adapting, editing, setting and resetting said relations, compositions and compilations related to said individual providers by said individual providers and/or said individual providers' staff and employees using said interactive blank boxes for generating, enabling, adjusting, editing, updating, adapting, setting and resetting said individual costs, rates, values and charges related to said individual providers and, consequently, in said processor units, memories and adaptable and expanding SQL databases; and
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

5. The process for keyboarding and/or touch-screening said numerous linked interactive pop-up and drop-down lists to create and generate individual relations and compositions on said individual costs, rates, values or charges related to said individual payables related to said individual providers related to individual medical or surgical specialties or practices related to information and data on office and practice locations and addresses such as, but not limited to, individual zip codes or area codes in said interactive blank boxes and submitting said relations and compositions by said individual providers and/or said individual providers' staff and employees to said processor units and memories from which said relations and compositions are outputted to, related to individual SQL keys and compiled in said adaptable and expanding SQL databases according to claim 4 comprises:
a process for creating and generating relations and compositions on said fixed or non-negotiable costs, rates, values or charges related to individual payables related to said individual providers related to individual medical or surgical specialties or practices related to information and data on office and practice locations and addresses such as, but not limited to, individual zip codes or area codes in said interactive blank boxes for generating, enabling, adjusting, updating, adapting, setting and resetting said individual costs, rates, values or charges related to said individual payables related to said individual providers in said adaptable interactive linked Web pages and electronic templates and interactive blank boxes for creating and generating individual relations and compositions related to said individual providers in said servers and/or in said devices and submitting said relations and compositions by said individual providers and/or said individual providers' staff and employees to said processor units and memories from which said relations and compositions are outputted to, related to individual SQL keys and compiled in said adaptable and expanding SQL databases; and
a process for continually retrieving said relations, compositions and compilations in said adaptable and expanding SQL databases into said adaptable interactive linked Web pages and electronic templates in said viewing screens and adjusting, updating, adapting, editing, setting and resetting said relations, compositions and compilations related to said individual providers by said individual providers and/or said individual providers' staff and employees using said interactive blank boxes for generating, enabling, adjusting, updating, adapting, setting and resetting said individual costs, rates, values and charges related to said individual providers and, consequently, in said processor units, memories and adaptable and expanding SQL databases;
a process for computer-automatically and statistically analyzing said individual costs, rates, values and charges related to said individual providers related to individual medical or surgical specialties or practices and individual information and data on office and practice locations and addresses such as, but not limited to, zip codes or area codes related to physicians related to said individual medical or surgical specialties or practices and individual information and data on office and practice locations and addresses or said individual providers in same individual localities, places or regions in America or other nations;
a process for computer-automatically and statistically analyzing said individual costs, rates, values and charges related to said individual providers related to individual medical or surgical specialties or practices and individual information and data on office and practice locations and addresses such as, but not limited to, zip codes or area codes and expenses, overheads, capital and equipment costs and deductions related to physicians related to said individual medical or surgical specialties or practices and individual information and data on office and practice locations and addresses or said individual providers in same individual localities, places or regions in America or other nations; and
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

6. The method according to claim 2 wherein said process for computer-automatically creating and generating adaptable relations, compositions and compilations of said individual costs, prices, values and fees and related said bids and counteroffers and related individual payables related to individual providers and related medical and surgical specialities or practices and related individual buyers and related non-health and non-health-care services, goods, equipment and related information and data on office, practice, business and residence locations and addresses of said individual providers and said physicians and individual buyers in said processor units, memories and in said adaptable and expanding SQL databases in said servers comprises:
a process for computer-automatically and continually generating adaptable interactive linked Web pages and electronic templates and numerous linked interactive pop-up and drop-down lists and said interactive blank boxes in said viewing screens of said devices and in said teleconferencing platforms;
said process for accessing said servers by said individual providers and/or said individual providers' staff and employees using said devices and upon prompting by said devices, a process for computer-automatically and continually generating individual electronic templates comprising said individual words, terms and phrases related to said individual payables related to said individual medical or surgical specialties or practices and related individual interactive blank boxes for keyboarding and/or touch-screening individual ask costs, rates, values and charges to relate and compose said relations and compositions of said individual words, terms and phrases and related payables in said adaptable interactive linked Web pages and electronic templates, enabled and effected by at least HTML, Java Script and AJAX and enabled and effected by and according to said innovative computer programs and software and stored procedures, in said servers and/or said viewing screens of said devices and teleconferencing platforms;
a process for creating and generating successive or sequential individual adaptable relations, compositions and compilations of individual negotiable, variable and adjustable individual costs, rates, values and charges and related individual bids and counteroffers and related negotiated and agreed or set individual costs, rates or charges related to said individual payables or non-health and non-health-care services, goods, equipment related to said individual providers related to individual medical and surgical specialties or practices and related said individual buyers including individual patients and related information and data on office, practice, business and residence locations and addresses by and between said individual providers, and/or said individual providers' staff and employees, and related individual buyers, and/or said individual buyers' staff and employees including individual patients, in same individual localities, places or regions in America or other nations, in said processor units and memories and SQL databases in said servers, in different and diverse settings, localities, places and regions in America and other nations;
a process for creating and generating successive or sequential individual adaptable relations, compositions and compilations of individual negotiable, variable and adjustable individual costs, rates, values and charges and related individual bids and counteroffers and related negotiated and agreed or set individual costs, rates or charges related to said individual payables or non-health and non-health-care services, goods, equipment related to said individual providers related to individual medical and surgical specialties or practices and related said individual buyers including individual patients and related information and data on office, practice, business and residence locations and addresses by and between said individual providers, and/or said individual providers' staff and employees, and related individual buyers, and/or said individual buyers' staff and employees including individual patients, in said processor units and memories and SQL databases in said servers, in different and diverse settings, localities, places and regions in America and other nations;
a process for computer-automatically and successively or sequentially mathematical calculating, computing and statistically analyzing and manipulating said successive or sequential individual relations, compositions and compilations of said individual costs, rates, values and charges related to said individual payables and non-health and non-health-care services, goods, equipment related to said individual providers and related individual buyers and related information and data on office and practice locations and addresses in said processor units, memories and SQL databases in and manage by said SQL Server in said servers enabled and effected by and according to said innovative computer programs and software and stored procedures;
a process for computer-automatically and statistically analyzing said successive or sequential individual adaptable relations, compositions and compilations of individual negotiable, variable and adjustable individual costs, rates or charges related to said individual payables and non-health and non-health-care services, goods, equipment related to said individual providers and related individual buyers and related individual information and data on office and practice locations and addresses such as, but not limited to, zip codes or area codes related to said individual providers and individual buyers in same individual localities, places or regions in America or other nations;
a process for computer-automatically and statistically analyzing said successive or sequential individual adaptable relations, compositions and compilations of individual negotiable, variable and adjustable individual costs, rates or charges related to said individual payables and non-health and non-health-care services, goods, equipment related to said individual providers and related individual buyers and related individual information and data on office and practice locations and addresses such as, but not limited to, zip codes or area codes and expenses, overheads, capital and equipment costs and deductions related to said individual providers related to said individual medical or surgical specialties or practices and individual information and data on office and practice locations and addresses or said individual providers in same individual localities, places or regions in America or other nations;
a process for computer-automatically and statistically analyzing said individual costs, rates, values and charges related to said individual providers related to individual medical or surgical specialties or practices and individual information and data on office and practice locations and addresses such as, but not limited to, zip codes or area codes and expenses, overheads, capital and equipment costs and deductions related to individual providers related to said individual medical or surgical specialties or practices and individual information and data on office and practice locations and addresses or said individual providers in same individual localities, places or regions in America or other nations;
a process for computer-automatically generating and applying individual statistical outcomes of individual computer-generated statistics on said successive or sequential individual adaptable relations, compositions and compilations to affect and effect said individual negotiable or adjustable costs, prices, values and fees and related counter-bid and counter-offered costs, prices, values or fees and related settled, agreed or negotiated costs, prices, values and fees by and among and related to said individual providers and said individual buyers in said interactive blank boxes in said adaptable interactive linked Web pages and electronic templates and, subsequently, in said processor units and memories and outputting said individual bids, counteroffers and settled, agreed or negotiated costs, prices, values and fees to, related to SQL keys and compiled in said SQL databases in and manage by said SQL Server in said server;
a process for continually retrieving and viewing said relations, compositions and compilations in said SQL databases in said viewing screens and, consequently, adjusting, updating, adapting, editing, setting and resetting said relations, compositions and compilations in said processor units, memories and adaptable and expanding SQL databases in said servers by and among said individual providers and/or said individual providers' staff and employees and said individual buyers and/or said individual buyers' staff and employees, who are in same individual localities, places or regions in America or other nations, using said interactive blank boxes in said Servers and/or in said adaptable interactive linked Web pages and electronic templates in said viewing screens and, consequently,
effected by said individual providers and/or said individual providers' staff and employees and/or said individual buyers and/or said individual buyers' staff and employees and individual patients, using said devices in said network or networks, who are in places, localities, regions, cities and states in America and other nations, a process for computer-automatically and continually retrieving from said processor units, memories and SQL databases and displaying said adaptable relations, compositions and compilations and related calculations, computations and statistical analyzes and manipulations of said individual relations, compositions and compilations in said servers and displaying said relations, compositions and compilations in said servers and in said viewing screens of said devices and said teleconferencing platforms.

7. The process for creating and generating successive or sequential individual adaptable relations, compositions and compilations of individual negotiable, variable and adjustable individual costs, rates, values and charges and related individual bids and counteroffers and related negotiated and agreed or set individual costs, rates or charges related to said individual payables or non-health and non-health-care services, goods, equipment related to said individual providers related to individual medical and surgical specialties or practices and related said individual buyers including individual patients and related information and data on office, practice, business and residence locations and addresses by and between said individual providers, and/or said individual providers' staff and employees, and related individual buyers, and/or said individual buyers' staff and employees including individual patients, in same individual localities, places or regions in America or other nations, in said processor units and memories and SQL databases in said servers, in different and diverse settings, localities, places and regions in America and other nations according to claim 6 comprises:
said process for accessing said servers by said individual providers related by individual zip codes or area codes or individual groups of zip codes or area codes in same individual localities, places or regions in America or other nations and/or said providers' staff and employees using said devices and upon prompting by said devices, a process for computer-automatically and continually generating individual electronic templates comprising said individual words, terms and phrases representing individual payables related to said individual medical or surgical specialties or practices and related individual interactive blank boxes for keyboarding and/or touch-screening individual ask costs, rates, values and charges to relate and compose said relations and compositions of said individual words, terms and phrases in said adaptable interactive linked Web pages and electronic templates, enabled and effected by at least HTML, Java Script and AJAX and submitting said relations and compositions to said processor units and memories from which said relations and compositions are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures,
a computer-automatically calculating, computing and statistical analyzing said individual costs, rates, values and charges related to said individual payables related to said individual providers related by individual zip codes or area codes or individual groups of zip codes or area codes in same individual localities, places or regions in America or other nations to computer-automatically producing individual averages, means or medians of said individual ask costs, rates, values and charges and related individual standard deviations or variances related to said individual providers in said same individual localities, places or regions in America or other nations in said processor units and memories from which said relations and compositions comprising individual averages, means or medians and related individual standard deviations or variances related to said individual providers in said same individual localities, places or regions in America or other nations and are outputted to said adaptable and expanding SQL databases in and manage by said SQL Server,
said process for accessing said servers by said buyers related by individual zip codes or area codes or individual groups of zip codes or area codes in same individual localities, places or regions in America or other nations and/or said buyers' staff and employees using said devices, a process for accessing said servers by said buyers related to said individual providers related by individual zip codes or area codes or individual groups of zip codes or area codes in same individual localities, places or regions in America or other nations and/or said buyers' staff and employees including individual patients using said devices and upon prompting by said devices, a process for computer-automatically retrieving and generating said relations and compositions of said individual averages, means or medians of said individual ask costs, rates, values and charges and related individual standard deviations or variances related to said individual providers in said same individual localities, places or regions in America or other nations in said processor units and memories and displaying said relations and compositions accompanied by said interactive blank boxes in said adaptable said adaptable interactive linked Web pages and electronic templates viewable and usable by said individual buyers related to said individual providers by said individual zip codes or area codes or individual groups of zip codes or area codes in same individual localities, places or regions in America or other nations, and/or said individual buyers' staff and employees; and, subsequently,
a process for generating individual cost, rate, value and charge bids to said individual providers' or physicians' individual averages, means or medians of said individual ask costs, rates, values and charges by keyboarding and/or touch-screening said individual cost, rate, value and charge bids into said interactive blank boxes and submitting said relations and compositions by said individual buyers, and/or said buyers' staff and employees to said processor units and memories from which said relations and compositions are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures;
a computer-automatically calculating, computing and statistical analyzing said individual cost, rate, value and charge bids related to said individual payables related to said individual providers and related said buyers related by individual zip codes or area codes or individual groups of zip codes or area codes in same individual localities, places or regions in America or other nations to computer-automatically producing individual averages, means or medians of individual cost, rate, value and charge bids and related individual standard deviations or variances related to said individual payables related to said buyers and related said individual providers by said same individual localities, places or regions in America or other nations in said processor units and memories from which said relations and compositions comprising individual cost, rate, value and charge bids and related individual standard deviations or variances related to said buyers in said same individual localities, places or regions in America or other nations and are outputted to, related to said relations, compositions and compilations in said adaptable and expanding SQL databases in and manage by said SQL Server,
said process for accessing said servers by said individual providers related by individual zip codes or area codes or individual groups of zip codes or area codes in same individual localities, places or regions in America or other nations and/or said providers' staff and employees using said devices, a process for accessing said servers by said individual providers related to said buyers related by said individual zip codes or area codes or individual groups of zip codes or area codes in same individual localities, places or regions in America or other nations and/or said providers' staff and employees using said devices and upon prompting by said devices, a process for computer-automatically retrieving and generating said relations and compositions of said individual averages, means or medians of said individual ask costs, rates, values and charges related to said individual providers and related said individual bids in said same individual localities, places or regions in America or other nations in said processor units and memories and displaying said relations and compositions accompanied by said interactive blank boxes in said adaptable said adaptable interactive linked Web pages and electronic templates viewable and usable by said individual providers related to said buyers by said individual zip codes or area codes or individual groups of zip codes or area codes in same individual localities, places or regions in America or other nations, and/or said individual providers' staff and employees; and, subsequently,
a process for generating individual cost, rate, value and charge counteroffers to said buyers' individual averages, means or medians of individual cost, rate, value and charge bids related to said individual payables by keyboarding and/or touch-screening said individual cost, rate, value and charge counteroffers into said interactive blank boxes and submitting said relations and compositions by said individual providers, and/or said providers' staff and employees to said processor units and memories from which said relations and compositions of said individual cost, rate, value and charge counteroffers are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures;
a computer-automatically calculating, computing and statistical analyzing said individual cost, rate, value and charge counteroffers related to said individual payables related to said buyers and related said individual providers related by individual zip codes or area codes or individual groups of zip codes or area codes in same individual localities, places or regions in America or other nations and to computer-automatically producing individual averages, means or medians of individual cost, rate, value and charge counteroffers and related individual standard deviations or variances related to said individual payables related to said individual providers and related said buyers by said same individual localities, places or regions in America or other nations in said processor units and memories from which said relations and compositions comprising individual cost, rate, value and charge counteroffers and related individual standard deviations or variances related to said individual providers in said same individual localities, places or regions in America or other nations and are outputted to, related to said relations, compositions and compilations in said adaptable and expanding SQL databases in and manage by said SQL Server,
a process for computer-automatically halting said processes after said computer-generated individual averages, means or medians of individual cost, rate, value and charge counteroffers and related individual standard deviations or variances are created in said processor units and memories; or
alternatively, a process for computer-automatically repeating said processes in said processor units and memories enabled and effected by and according to said individual providers and related said individual buyers by said same individual localities, places or regions in America or other nations in said processor units and memories from which said relations and compositions comprising individual cost, rate, value and charge bids or counteroffers and related individual standard deviations or variances related to said individual providers and related to said buyers by said same individual localities, places or regions in America or other nations and are outputted to, related to said relations, compositions and compilations in said adaptable and expanding SQL databases in and manage by said SQL Server, enabled and effected by and according to said innovative computer programs and software and stored procedures in said servers; and, eventually,
a process for continually retrieving said relations, compositions and compilations in said adaptable and expanding SQL databases into said adaptable interactive linked Web pages and electronic templates in said viewing screens and adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees using said interactive blank boxes for generating, enabling, adjusting, updating and adapting said individual costs, rates or charges related to said individual providers and related said individual buyers including individual patients and, consequently, in said processor units, memories and adaptable and expanding SQL databases;
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

8. The process for continually retrieving said relations, compositions and compilations in said adaptable and expanding SQL databases into said adaptable interactive linked Web pages and electronic templates in said viewing screens and adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees using said interactive blank boxes for generating, enabling, adjusting, updating and adapting said individual costs, rates or charges related to said individual providers and related said individual buyers including individual patients according to claim 7 comprises:
effected by said individual providers or said individual physicians and/or said individual providers' or physicians' staff and employees and/or said individual buyers and/or said individual buyers' staff and employees including individual patients, using said devices in said network or networks, who are in places, localities, regions, cities and states in America and other nations, said process for computer-automatically and continually retrieving from said processor units, memories and adaptable and expanding SQL databases and displaying said relations, compositions and compilations in said servers and in said viewing screens of said devices and said teleconferencing platforms;
a process for adjusting, editing, setting and resetting said individual negotiated, settled or set individual costs, rates, values and charges related to said individual payables related to said individual providers or individual physicians related to individual medical or surgical specialties or practices in said SQL databases using said interactive blank boxes and submitting by said individual providers or said physicians and/or said individual providers' or physicians' staff and employees said edited or new relations and compositions related to said individual providers or individual physicians to said processor units and memories from which said new relations and compositions are outputted, related and compiled is said SQL databases;
a computer-automatically calculating, computing and statistical analyzing said individual new costs, rates, values and charges related to said individual payables related to said individual providers or said individual physicians related by individual medical or surgical specialties or practices related by individual zip codes or area codes or individual groups of zip codes or area codes in same individual localities, places or regions in America or other nations and to computer-automatically producing individual averages, means or medians of individual edited costs, rates, values and charges and related individual standard deviations or variances related to said individual payables related to said individual providers or said individual physicians in said processor units and memories from which said relations and compositions are outputted to, related to said relations, compositions and compilations in said adaptable and expanding SQL databases in and manage by said SQL Server, and
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

9. The process for creating and generating successive or sequential individual adaptable relations, compositions and compilations of individual negotiable, variable and adjustable individual costs, rates, values and charges and related individual bids and counteroffers and related negotiated and agreed or set individual costs, rates or charges related to said individual payables or non-health and non-health-care services, goods, equipment related to said individual providers related to individual medical and surgical specialties or practices and related said individual buyers including individual patients and related information and data on office, practice, business and residence locations and addresses by and between said individual providers, and/or said individual providers' staff and employees, and related individual buyers, and/or said individual buyers' staff and employees including individual patients, in said processor units and memories and SQL databases in said servers, in different and diverse settings, localities, places and regions in America and other nations according to claim 6 comprises:
said process for accessing said servers by said individual providers or individual physicians related by individual zip codes or area codes or individual groups of zip codes or area codes in same individual localities, places or regions in America or other nations and/or said providers' staff and employees using said devices and upon prompting by said devices, a process for computer-automatically and continually generating individual electronic templates comprising said individual words, terms and phrases representing individual payables related to said individual medical or surgical specialties or practices and related individual interactive blank boxes for keyboarding and/or touch-screening individual ask costs, rates, values and charges to relate and compose said relations and compositions of said individual words, terms and phrases in said adaptable interactive linked Web pages and electronic templates, enabled and effected by at least HTML, Java Script and AJAX and submitting said relations and compositions to said processor units and memories from which said relations and compositions are outputted to said adaptable and expanding SQL databases in and manage by said SQL Server enabled and effected by and according to said innovative computer programs and software and stored procedures in said servers; and, consequently, enabled and effected by and according to said innovative computer programs and software and stored procedures,
a computer-automatically calculating, computing and statistical analyzing said individual costs, rates, values and charges related to said individual payables related to said individual providers related by individual zip codes or area codes or individual groups of zip codes or area codes in same individual localities, places or regions in America or other nations to computer-automatically producing individual averages, means or medians of said individual ask costs, rates, values and charges and related individual standard deviations or variances related to said individual providers or individual physicians in said same individual localities, places or regions in America or other nations in said processor units and memories from which said relations and compositions comprising individual averages, means or medians and related individual standard deviations or variances related to said individual providers in said same individual localities, places or regions in America or other nations and are outputted to said adaptable and expanding SQL databases in and manage by said SQL Server;
said process for accessing said servers by said individual buyers and/or said buyers' staff and employees including individual patients in individual localities, places or regions in America and other nations by using said devices and upon prompting by said devices, a process for computer-automatically retrieving and generating said relations and compositions of said individual averages, means or medians of said individual ask costs, rates, values and charges and related individual standard deviations or variances related to said individual providers or said individual physicians in said processor units and memories and displaying said relations and compositions accompanied by said interactive blank boxes in said adaptable said adaptable interactive linked Web pages and electronic templates viewable and usable by said individual buyers and/or said buyers' staff and employees including individual patients; and, subsequently,
a process for generating individual cost, rate, value and charge bids to said individual providers' or individual physicians' individual averages, means or medians of said individual ask costs, rates, values and charges by keyboarding and/or touch-screening said individual cost, rate, value and charge bids, in individual national currencies and exchanges including non-health and non-health-care services, goods, equipment into said interactive blank boxes and submitting said relations and compositions by said individual buyers, and/or said buyers' staff and employees including individual patients to said processor units and memories from which said relations and compositions are outputted to said adaptable and expanding SQL databases in and manage by said SQL Server;
a computer-automatically calculating, computing and statistical analyzing said individual cost, rate, value and charge bids related to said individual payables related to said individual providers and related to said individual buyers including individual patients related and computer-automatically producing individual averages, means or medians of individual cost, rate, value and charge bids and related individual standard deviations or variances related to said individual payables related to said individual buyers including individual patients in said processor units and memories from which said relations and compositions comprising individual cost, rate, value and charge bids and related individual standard deviations or variances related to individual buyers including individual patients related by individual localities, places or regions in America and other nations and are outputted to, related to said relations, compositions and compilations in said adaptable and expanding SQL databases in and manage by said SQL Server;
said process for accessing said servers by said individual providers and/or said providers' staff and employees using said devices and upon prompting by said devices, a process for computer-automatically retrieving and generating said relations and compositions of said individual averages, means or medians of said individual ask costs, rates, values and charges related to said individual providers and related said individual bids in said processor units and memories and displaying said relations and compositions accompanied by said interactive blank boxes in said adaptable said adaptable interactive linked Web pages and electronic templates viewable and usable by said individual providers related to said individual buyers including individual patients; and, subsequently,
a process for generating individual cost, rate, value and charge counteroffers to said individual buyers' and individual patients' individual averages, means or medians of individual cost, rate, value and charge bids related to said individual payables by keyboarding and/or touch-screening said individual cost, rate, value and charge counteroffers into said interactive blank boxes and submitting said relations and compositions by said individual providers, and/or said providers' staff and employees to said processor units and memories from which said relations and compositions of said individual cost, rate, value and charge counteroffers are outputted to said adaptable and expanding SQL databases;
a computer-automatically calculating, computing and statistical analyzing said individual cost, rate, value and charge counteroffers related to said individual buyers and individual patients and related said individual providers and computer-automatically producing individual averages, means or medians of individual cost, rate, value and charge counteroffers and related individual standard deviations or variances related to said individual payables related to said individual providers and related said individual buyers and individual patients in said processor units and memories from which said relations and compositions comprising individual cost, rate, value and charge counteroffers and related individual standard deviations or variances related to said individual providers in said processor units and memories from which said relations and compositions are outputted to, related to said relations, compositions and compilations and compiled in said adaptable and expanding SQL databases in and manage by said SQL Server,
a process for computer-automatically halting said processes after said computer-generated individual averages, means or medians of individual cost, rate, value and charge counteroffers and related individual standard deviations or variances are created in said processor units and memories; enabled and effected by and according to said innovative computer programs and software and stored procedures in said servers; or
alternatively, a process for computer-automatically repeating said processes in said processor units and memories enabled and effected by and according to said individual providers and related said individual buyers in said processor units and memories from which said relations and compositions are outputted to, related to said relations, compositions and compilations in said adaptable and expanding SQL databases in and manage by said SQL Server;
a process for continually retrieving said relations, compositions and compilations in said adaptable and expanding SQL databases into said adaptable interactive linked Web pages and electronic templates in said viewing screens and adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees using said interactive blank boxes for generating, enabling, adjusting, updating and adapting said individual costs, rates or charges related to said individual providers and related said individual buyers including individual patients and, consequently, in said processor units, memories and adaptable and expanding SQL databases;
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.

10. The method according to claim 2 wherein said process for computer-automatically and sequentially calculating, computing, statistically analyzing said individual ask costs, prices, values and fees and related said bids and counteroffers related to said individual payables or non-health and non-health-care services, goods, equipment in said processor units and memories from which said calculations, computations and statistics on and related to said individual ask costs, prices, values and fees and related said bids and counteroffers are outputted to, relate and compiled in said adaptable and expanding SQL databases in said servers includes:
said computer-automatically calculating, computing and statistical analyzing said individual costs, rates, values and charges related to said individual payables related to said individual providers related by individual zip codes or area codes or individual groups of zip codes or area codes in same individual localities, places or regions in America or other nations to computer-automatically producing individual averages, means or medians of said individual ask costs, rates, values and charges and related individual standard deviations or variances related to said individual providers in said same individual localities, places or regions in America or other nations in said processor units and memories from which said relations and compositions comprising individual averages, means or medians and related individual standard deviations or variances related to said individual providers in said same individual localities, places or regions in America or other nations and are outputted to said adaptable and expanding SQL databases in and manage by said SQL Server,
said computer-automatically calculating, computing and statistical analyzing said individual cost, rate, value and charge bids related to said individual payables related to said individual providers or physicians and related said buyers related by individual zip codes or area codes or individual groups of zip codes or area codes in same individual localities, places or regions in America or other nations to computer-automatically producing individual averages, means or medians of individual cost, rate, value and charge bids and related individual standard deviations or variances related to said individual payables related to said buyers and related said individual providers by said same individual localities, places or regions in America or other nations in said processor units and memories from which said relations and compositions comprising individual cost, rate, value and charge bids and related individual standard deviations or variances related to said buyers in said same individual localities, places or regions in America or other nations and are outputted to, related to said relations, compositions and compilations in said adaptable and expanding SQL databases in and manage by said SQL Server;
said computer-automatically calculating, computing and statistical analyzing said individual cost, rate, value and charge counteroffers related to said individual payables related to said buyers and related said individual providers related by individual zip codes or area codes or individual groups of zip codes or area codes in same individual localities, places or regions in America or other nations and to computer-automatically producing individual averages, means or medians of individual cost, rate, value and charge counteroffers and related individual standard deviations or variances related to said individual payables related to said individual providers and related said buyers by said same individual localities, places or regions in America or other nations in said processor units and memories from which said relations and compositions comprising individual cost, rate, value and charge counteroffers and related individual standard deviations or variances related to said individual providers in said same individual localities, places or regions in America or other nations and are outputted to, related to said relations, compositions and compilations in said adaptable and expanding SQL databases in and manage by said SQL Server, and
said process for computer-automatically halting said processes after said computer-generated individual averages, means or medians of individual cost, rate, value and charge counteroffers and related individual standard deviations or variances are created in said processor units and memories.

11. The method according to claim 2 wherein said process for computer-automatically applying said calculations, computations and statistics related to said individual providers and related individual buyers and individual patients and related said information and data on office, practice, business and residence locations and addresses for guiding and effecting said generations of said relations and compositions of said individual bids and counteroffers and related negotiated and agreed or set individual costs, rates, values and charges of, by and between said individual providers and individual buyers including individual patients in said processor units, memories and adaptable and expanding SQL databases comprises:
said process for creating and generating successive or sequential individual adaptable relations, compositions and compilations of individual negotiable, variable and adjustable individual costs, rates, values and charges and related negotiated and agreed or set individual costs, rates or charges related to said individual payables or non-health and non-health-care services, goods, equipment related to said individual providers related to individual medical and surgical specialties or practices and related said buyers and related information and data on office and practice, business locations and addresses by and between said individual providers, and/or said providers' staff and employees, and related buyers, and/or said buyers' staff and employees, in same individual localities, places or regions in America or other nations, in said processor units, memories and adaptable SQL databases in and manage by said SQL Server in said servers using said adaptable interactive linked Web pages and electronic templates and numerous linked interactive pop-up and drop-down lists and related said interactive blank boxes;
said process for computer-automatically and continually retrieving from said processor units, memories and adaptable and expanding SQL databases and displaying said relations, compositions and compilations comprising said individual averages, means or medians of said individual ask costs, rates, values and charges, said individual averages, means or medians of individual cost, rate, value and charge bids and said individual cost, rate, value and charge counteroffers related to said physicians or individual providers and related individual buyers related by related by said information and data on office, practice, business locations and addresses in same individual localities, places or regions in America or other nations or in different and diverse settings, localities, places and regions in America and other nations in said adaptable interactive linked Web pages and electronic templates related to said interactive blank boxes in said viewing screens;
a process for computer-automatically applying said individual standard deviations or variances related to said individual averages, means or medians of said individual ask costs, rates, values and charges, said individual averages, means or medians of individual cost, rate, value and charge bids and said individual cost, rate, value and charge counteroffers in said processor units and memories; and
for computer-automatically guiding and enabling or allowing said keyboarding and/or touch-screening into said individual interactive blank boxes by and among said individual providers, and/or said providers' staff and employees and said related individual buyers, and/or said buyers' staff and employees:
i) said individual ask costs, rates, values and charges generated by said individual providers;
ii) said individual bid costs, rates, values and charges generated by said individual buyers and related to said individual averages, means or medians of said individual ask costs, rates, values and charges; and
iii) said individual counteroffer costs, rates, values and charges generated by said individual providers and related to said individual averages, means or medians of individual cost, rate, value and charge bids in said interactive blank boxes and submitting said individual costs, rates, values and charges to said processor units and memories and outputted to said adaptable and expanding SQL databases in and manage by said SQL Server in said servers.

12. The method according to claim 2 wherein said process for setting and resetting or switching and applying various combinations and applications of said fixed prices, costs, values and fees and/or said negotiated, settled or set prices, costs, values and fees among said related individual buyers in said functioning and operating computerized systems of payments and related disbursements and barters in said servers by said individual providers comprises:
a process for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers and related settled, agreed or negotiated costs, prices, values and fees related to individual payables and related non-health and non-health-care goods and services by and among said individual buyers, individual patients and said individual providers using said devices for accessing said servers;
a process for computer-automatically creating and generating individual adaptable relations, compositions and compilations of said individual costs, prices, values and fees and related individual payables related to individual providers related to medical or surgical specialities or practices and related information and data on office and practice locations and addresses in said processor units, memories and in said adaptable and expanding SQL databases in said servers;
a process for computer-automatically creating and generating adaptable relations, compositions and compilations of said individual costs, prices, values and fees and related said bids and counteroffers and related settled, agreed or negotiated costs, prices, values and fees related individual payables related to individual providers and related medical and surgical specialities or practices and related individual buyers and related non-health and non-health-care services, goods, equipment and related information and data on office, practice, business and residence locations and addresses of said individual providers and individual buyers including individual patients in said processor units, memories and in said adaptable and expanding SQL databases in said servers; and
a process for setting and resetting or switching and applying various combinations or permutations of said fixed prices, costs, values and fees and/or said negotiated, settled or set prices, costs, values and fees related to and among said individual buyers related to said individual providers by said individual providers and computer-automatically applying said relations of said fixed prices, costs, values and fees and/or said negotiated, settled or set prices, costs, values and fees related to said individual buyers related to said individual providers in said functioning and operating computerized systems of payments and related disbursements and barters, enabled and effected by and according to said innovative computer programs and software and stored procedures in said servers.

13. The method according to claim 2 wherein said process for computer-automatically applying said fixed prices, costs, values and fees and/or said negotiated, settled or set prices, costs, values and fees related to individual payables in individual medical or surgical specialties or practices related to individual providers related to individual patients—related to said individual buyers in same or different and diverse settings, localities, places and regions in America and other nations—who are provided said individual payables by said individual providers in individual localities, places or regions in America and other nations comprises:
a process for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers and related settled, agreed or negotiated costs, prices, values and fees related to individual payables and related non-health and non-health-care goods and services by and among said individual buyers, individual patients and said individual providers using said devices for accessing said servers; and
a process for setting and applying said fixed prices, costs, values and fees and/or said negotiated, settled or set prices, costs, values and fees related to said individual providers provided said individual payables to said individual patients in same individual localities, places or regions in America or other nations in said servers by said individual providers, and/or said providers' staff and employees using said devices and, consequently, computer-automatically applying said relations of said fixed prices, costs, values and fees and/or said negotiated, settled or set prices, costs, values and fees and said individual patients, related to said individual buyers, in said functioning and operating computerized systems of payments and related disbursements and barters, enabled and effected by and according to said innovative computer programs and software and stored procedures in said servers.

14. The process for setting and applying said fixed prices, costs, values and fees and/or said negotiated, settled or set prices, costs, values and fees related to said individual providers provided said individual payables to said individual patients in same individual localities, places or regions in America or other nations in said servers by said individual providers, and/or said providers' staff and employees using said devices according to claim 13 includes:
said process for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers and related settled, agreed or negotiated costs, prices, values and fees related to individual payables and related non-health and non-health-care goods and services by and among individual buyers, individual patients and individual providers using said devices for accessing said servers; and
a process for establishing relations and compositions of said fixed prices, costs, values and fees and/or said negotiated, settled or set prices, costs, values and fees and related non-health and non-health-care goods and services in said processor units, memories and SQL databases and computer-automatically generating relations and compositions of said individual payables related to said fixed prices, costs, values and fees and/or said negotiated, settled or set prices, costs, values and fees related to said individual providers and related individual patients or related said individual patients related to said individual buyers in said processor units and memories from which said relations and compositions are outputted to, related and compiled in said SQL databases, enabled and effected by and according to said innovative computer programs and software and stored procedures in said servers.

15. The method according to claim 2 wherein said process for computer-automatically creating and generating adaptable relations, compositions and compilations of individual costs, prices, values and fees related to information and data on said individual non-health and non-health-care services, goods, equipment related to individual buyers and individual patients and related individual providers and related said individual ask costs, prices, values and fees related to said individual payables in America and other nations in said servers in said network or networks comprises:
said process for generating relations and compositions on information and data on said individual providers including office and practice locations and addresses on said individual providers and related individual medical or surgical specialties or practices, related said individual negotiable or adjustable ask costs, prices, values and fees, related said cost, price, value and fee counteroffers and said settled, agreed or negotiated costs, prices, values and fees related to individual payables by said individual providers and/or said individual providers' staff and employees using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled in said adaptable and expanding SQL databases in and manage by said SQL Server in said servers;
a process for generating relations and compositions on information and data on said individual buyers including office and business locations and addresses on said individual buyers and related information and data on said non-health-care goods and services and related individual negotiable or adjustable ask costs, prices, values and fees by said individual buyers and/or said individual buyers' staff and employees using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled with related said individual providers' relations, compositions and compilations in said adaptable and expanding SQL databases;
a process for generating relations and compositions on information and data on said individual patients including office and business locations and addresses on said individual patients and related information and data on said non-health-care goods and services and related individual negotiable or adjustable ask costs, prices, values and fees by said individual patients and/or said individual patients staff and employees using said adaptable interactive linked Web pages and electronic templates and linked numerous interactive pop-up and drop-down lists and interactive blank boxes in said viewing screens of said devices for generating and submitting said relations and compositions via the Internet to said processor units and memories from which said relations and compositions are computer-automatically outputted to, related to individual SQL keys and compiled with related said individual providers' relations, compositions and compilations in said adaptable and expanding SQL databases;
a process for continually retrieving said relations, compositions and compilations in said adaptable and expanding SQL databases into said adaptable interactive linked Web pages and electronic templates in said viewing screens and adjusting, editing, setting and resetting said relations, compositions and compilations in said interactive linked Web pages and electronic templates, processor units and memories and SQL databases by and among said individual providers and/or said individual providers' staff and employees, said individual buyers and/or said individual buyers' staff and employees and said individual patients using said interactive blank boxes for generating, enabling, adjusting, editing, updating and adapting said relations, compositions and compilations in said adaptable interactive linked Web pages and electronic templates and, consequently, in said processor units, memories and adaptable and expanding SQL databases; and, consequently,
a process for computer-automatically and continually creating and generating individual desirable or suitable relations, compositions and compilations among said individual providers, individual buyers and individual patients in said processor units, memories and SQL databases upon prompting said servers by individual providers, individual buyers and/or individual patients using adaptable interactive linked Web pages and electronic templates and linked numerous interactive pop-up and drop-down lists and interactive blank boxes for generating instructions or queries to said servers for responding by creating and generating said individual desirable or suitable relations, compositions and compilations for affecting and effecting individual searches, finds, trades, exchanges and/or purchases of said individual payables and said individual non-health and non-health-care services, goods, equipment by and among said among said individual providers, individual buyers and individual patients in said network or networks.

16. In a computerized system for generating and managing adaptable and expanding relations, compositions and compilations of individual non-negotiable or fixed ask costs, prices, values or fees and related individual payable health and health-care services, tests, goods, equipment and medications henceforth individual payables generated by and related to physicians, individual physicians, individual groups of physicians, hospitals, individual hospitals, clinics, individual health-care clinics, facilities, individual health-care facilities, departments or individual departments henceforth collectively known as individual providers and relations, compositions and compilations of individual negotiable or adjustable ask costs, prices, values and fees related to individual payables related to individual providers and related cost, price, value and fee bids and related cost, price, value and fee counteroffers and related settled, agreed or negotiated costs, prices, values and fees related to and among said individual providers and health-care buyers, individual health-care buyers, individual groups of health-care buyers or individual governments henceforth collectively known as individual buyers related to said individual payables and non-health and non-health-care goods and services generated and composed by and between said individual providers and related individual buyers in same individual localities, places or regions in America or other nations or in different and diverse settings, localities, places and regions in America and other nations in adaptable and expanding SQL databases in and manage by a SQL Server in a operating and functioning computer server or servers henceforth servers for enabling, generating and managing said relations, compositions and compilations related to said individual providers and individual buyers for enabling and effecting the applications of said relations, compositions and compilations for managing human resources and managing and controlling health-care funds and resources including costs of individual payables of and for said individual providers and individual buyers in said servers in a network or networks of said servers, and computers, laptops, mobile and wireless communication devices, teleconferencing platforms and related devices and the Internet henceforth devices, a method for computer-automatically enabling and managing said relations, negotiations and compositions of said asks, bids and counteroffers and related negotiated costs, prices, values and fees related to said individual payables and non-health and non-health-care goods and services of, for and among said individual providers and individual buyers and enabling and effecting the computer-automatic applications of said relations and compositions for, by and among said individual providers and individual buyers in said servers for managing human resources and managing and controlling health-care funds and resources including said costs, prices, values and fees of said individual payables of, for and among said individual providers and individual buyers in said servers in said network or networks comprises:
a process for operating said operating and functioning computer servers including said servers comprising a plurality of processor units, memories, server operating system, a networking capability comprising a Web browser, Web server, SQL Server, adaptable and expanding SQL databases in and manage by said SQL Server, computer scripting languages, JavaScript, AJAX, HTML, .net, Wordpad, Notepad, .txt programs, and said innovative computer programs and software coupled to, communicating with and commanding said SQL Server, processor units and memories, adaptable interactive linked Web pages and electronic templates and numerous linked interactive pop-up and drop-down lists in said viewing screens, a plurality of components of said computerized system and functioning and operating computerized systems of payments and related disbursements and barters, teleconferencing platforms comprising teleconferencing technologies and related devices and equipment, and said devices for accessing said servers and generating, adjusting, updating, adding, adapting, setting and resetting said adaptable and expanding SQL databases by and among said individual health-care buyers and individual health-care providers comprising keyboards and viewing screens including touch-enabled viewing screens or touchscreens, enabled by Web browsers and said Web server in said network or networks;
a process for creating, implementing and applying said innovative computer programs and software and stored procedures coupled to said processor units, memories and SQL Server in said servers;
a process for computer-automatically and continually generating adaptable interactive linked Web pages and electronic templates and numerous linked interactive pop-up and drop-down lists in said viewing screens, enabled by JavaScript, AJAX and HTML, innovative computer programs and software, stored procedures, Web browsers and Web server, comprising individual payables in medical and surgical categories of Evaluations, Laboratories, Imaging, Body Fluid Tests and Tissues Examinations, Medications, Devices, Equipment, Procedures, Treatments, Surgeries, Recommendations, Guidelines and Referrals related to individual diagnoses in medical and surgical specialties and practices related to said individual providers related to said medical and surgical specialties and practices and related information and data on office and practice locations and addresses such as, but not limited to, zip codes or area codes and related said relations and compositions of said costs, prices, values and fees and related bids and counteroffers related to said individual providers and individual buyers including individual patients and related interactive blank boxes for keyboarding and/or touch-screening said individual costs, prices, values and fees and related bids and counteroffers and related information and data on office, practice, business and residence locations and addresses for submitting to said processor units and memories and said adaptable and expanding SQL databases in and manage by said SQL Server and said interactive blank boxes for generating, adjusting, updating, adapting, editing, setting and resetting said relations, compositions and compilations related to said individual providers and related individual buyers and individual patients in said processor units, memories and said SQL databases;
a process for creating, generating, implementing and applying said adaptable and expanding SQL databases by said innovative computer programs and software and stored procedures coupled to said processor units, memories and SQL Server in said servers;
a process for computer-automatically creating, generating and maintaining adaptable relations, compositions and compilations of said information and data on said individual providers, said individual buyers and individual patients and related office, practice, business and residence locations and addresses on and related to said individual providers, buyers and patients related to medical or surgical specialties or practices and related said individual costs, prices, values and fees and related bids, counteroffers and negotiated or settled or set costs, prices, values and fees related to individual payables and related non-health and non-health-care goods and services by and among said individual buyers, individual patients and said individual providers using said devices for accessing said servers;
a process for computer-automatically creating and generating individual adaptable relations, compositions and compilations of said individual costs, prices, values and fees and related individual payables related to individual providers related to individual medical and/or surgical specialities or practices and related information and data on office and practice locations and addresses in said processor units, memories and in said adaptable and expanding SQL databases in said servers;
a process for computer-automatically creating, generating and maintaining adaptable relations, compositions and compilations of said information and data on office, practice, business and residence locations and addresses on and related to said individual buyers, related individual patients and related said individual providers related to medical or surgical specialties or practices and related said individual costs, prices, values and fees and related bids and counteroffers and related settled, agreed or negotiated costs, prices, values and fees related to individual payables and related non-health and non-health-care goods and services by and among said individual buyers, individual patients and said individual providers using said devices for accessing said servers;
a process for computer-automatically creating and generating adaptable relations, compositions and compilations of said individual costs, prices, values and fees and related said bids and counteroffers and related individual payables related to individual providers and related medical and surgical specialities or practices and related individual buyers and related non-health and non-health-care services, goods, equipment and related information and data on office, practice, business and residence locations and addresses of said individual providers and individual buyers in said processor units, memories and in said adaptable and expanding SQL databases in said servers;
a process for computer-automatically and sequentially calculating, computing, statistically analyzing said individual ask costs, prices, values and fees and related said bids and counteroffers related to said individual payables or non-health and non-health-care services, goods, equipment in said processor units and memories from which said calculations, computations and statistics on and related to said individual ask costs, prices, values and fees and related said bids and counteroffers are outputted to, relate and compiled in said adaptable and expanding SQL databases in said servers;
a process for computer-automatically applying said calculations, computations and statistics related to said individual providers and related individual buyers and individual patients and related said information and data on office, practice, business and residence locations and addresses for guiding and effecting said generations of said relations and compositions of said individual bids and counteroffers and related negotiated and agreed or set individual costs, rates, values and charges of, by and between said individual providers and individual buyers including individual patients in said processor units, memories and adaptable and expanding SQL databases;
a process for continually retrieving said relations, compositions and compilations in said adaptable and expanding SQL databases into said adaptable interactive linked Web pages and electronic templates in said viewing screens and adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees using said interactive blank boxes for generating, enabling, adjusting, updating and adapting said individual costs, rates or charges related to said individual providers and related said individual buyers including individual patients and, consequently, in said processor units, memories and adaptable and expanding SQL databases;
a process for setting and resetting or switching and applying various combinations and applications of said fixed prices, costs, values and fees and/or said negotiated, settled or set prices, costs, values and fees among said related individual buyers in said functioning and operating computerized systems of payments and related disbursements and barters in said servers by said individual providers;
a process for continually adjusting, editing, setting and resetting said relations, compositions and compilations of said individual costs, rates and charges related to individual payables in said interactive linked Web pages and electronic templates, processor units and memories and SQL databases by said individual providers or said individual physicians and/or said individual providers' or physicians' staff and employees;
a process for computer-automatically applying said fixed prices, costs, values and fees and/or said negotiated, settled or set prices, costs, values and fees related to individual payables in individual medical or surgical specialties or practices related to individual providers related to individual patients—related to said individual buyers in same or different and diverse settings, localities, places and regions in America and other nations—who are provided said individual payables by said individual providers in individual localities, places or regions in America and other nations;
a process for computer-automatically creating and generating adaptable relations, compositions and compilations of individual costs, prices, values and fees related to information and data on said individual non-health and non-health-care services, goods, equipment related to individual buyers and individual patients and related individual providers and related said individual ask costs, prices, values and fees related to said individual payables in America and other nations in said servers in said network or networks; and
effected by said individual providers and/or said individual providers' staff and employees and/or said individual buyers and/or said individual buyers' staff and employees including individual patients, using said devices in said network or networks, who are in places, localities, regions, cities and states in America and other nations, a process for computer-automatically and continually retrieving from said processor units, memories and adaptable and expanding SQL databases and displaying said relations, compositions and compilations in said servers and in said viewing screens of said devices and said teleconferencing platforms.
